(19) United States
(12) Patent Application Publication
(10) Pub. No.: US 2004/0028505 A1
(43) Pub. Date: Feb. 12, 2004

(54) Document tape binding system with automatic tape feed, tape indicia sensing, spine printing method and post-bind automation mechanisms

(76) Inventor: Robert A. Bilbrey, Orinda, CA (US)

Correspondence Address: Robert A. Bilbrey, 7 La Campagna, Orinda, CA, 94563, US

(21) Appl. No.: 10/453,013

(22) Filed: May 31, 2003

Related U.S. Application Data
(60) Provisional application No. 60/387,263, filed on Jun. 7, 2002.

(51) Int. Cl. B42C 9/00

(52) U.S. Cl. 412/8

(57) ABSTRACT

A desktop binder for converting a plurality of sheets of paper into book form using a flexible binding media, or binder-tape, to attach the book spine and covers. The binder-tape is pre-coated with a hot melt adhesive and includes indicia that the binder can decode. The binder can utilize binder-tape both in roll or sheet format where the width of said binder-tape is equal to the long bound edge of the book. The binder-tape is cut to the desired size automatically by a mechanism within the binder. A method is presented for preprinting a spine title on the sheet form of binder-tape. The book is gripped by a roller mechanism that shuttles the book through the various process stages. The completed book may be ejected either from the opening into which it was inserted or, alternatively, transferred through a secondary opening communicating with a book-stacking unit or conveyor.

### CROSS-REFERENCE TO RELATED APPLICATIONS

This application is entitled to the benefit of Provisional Patent Application Serial No. 60/387,263 filed Jun. 7, 2002.

### BACKGROUND

1. Field of the Invention

This invention relates to the low volume binding of documents into a book form, and more specifically to mechanisms and methods simplifying and improving the efficiency of the binding, spine printing and book handling operations.

2. Background of the Invention

There are several well-known methods of binding documents into a book-like form. Many of these methods, such as the so-called “perfect binding” systems are mainly suitable for high volume binding. Other methods, such as “comb binding” and “spiral wire” binding are applicable to the short-run market but are less desirable for cosmetic and practical reasons.

These historical binding methods do not adequately address the demands of the emerging “desktop publishing” and “print-on-demand” movements made viable by the recent introduction of fast, affordable printers and copiers.

Most of the short to medium-run binding systems are not capable of printing a document title on the spine of the book without expensive additional equipment.

Potentially, for many reasons, the best print-on-demand binding method is what is known as the “tape binding” method. A well-designed tape binder produces a cosmetically handsome book with durable, strongly bound pages. Tape binders utilize a pre-coated adhesive strip that is wider than the thickness of the book to attach the spine of a document bundle. The strip is then formed up for a short distance along the front and the back cover sheets and the adhesive, thus adjacent to the front and rear sheets, secures the tape to the two covers. Usually the adhesive employed is a hot melt product although pressure sensitive glues have been used alone or in combination with hot melts.

The ideal tape binder should comprise affordability, flexibility, minimal auxiliary equipment, speed of bind, very fast setup, spine printing capability, energy conservation, low maintenance, and low noxious fume production. Furthermore, the modern tape binder should have the capability of being easily automated to work in conjunction with the current and future crop of printers and copiers. The ideal binder should have internal binder-tape storage and feed mechanism. The binder should possess an ability to stack the finished books for cooling and for transporting the stack for shipping or storage.

Several manufacturers currently produce tape binders. These binders lack many of the aforementioned attributes. The operation of these tape binders is universally manually intensive, requiring several serial steps spanning several minutes. In addition they usually require a warm-up period of from four to fifteen minutes from the power down state. Thus they are frequently kept continuously “on” in an energy inefficient manner. None of the present day tape binders known to this writer combine more than two or three of the features deemed desirable.

The effective implementation of “print-on-demand” calls for a system that can be affordably situated in a variety of locations such as bookstores, libraries, manufacturers, and law offices. Such a system should be capable of operating in a standalone or desktop mode or easily coupled to a printer or copier operating in an automatic or semi-automatic manner.

### SUMMARY OF THE INVENTION

A bookbinding and binding automation system is disclosed. The system, one that binds utilizing wide adhesive pre-coated tape, describes the binder and its associated binding materials. The binder-tape, in either sheet or roll formats, includes encoding indicia and is cut to length automatically. The binding system further includes methods for printing titles and images on the spine as well as describing mechanisms for automatic handling of the books after the bind is complete.

### OBJECT AND ADVANTAGES

The primary advantage of the invention is to provide the “Print-on-Demand” and the “Short/Medium Run” industries with a tape binder easily adaptable to advanced automation.

Another advantage is the ability to operate as a selectable dual mode device that can function independently as a “Desktop Binder” or can operate directly with its “Stacker/Cooler” to minimize labor input.

A further important feature is the provision for binder-tape internal storage with an attendant feed mechanism that substantially improves the binding system production rates.

Yet another advantage is the ease with which one may print on the spine of the book without the need for any costly external mechanisms.

Another feature of this invention utilizes devices and strategies to dramatically improve warm-up times and to demonstrate enhanced overall energy efficiency.

A boon of this invention is realized from its compact nature and attendant dramatic reduction in floor or desk space requirements

In accordance with the preferred embodiment of the invention, an apparatus is provided for accepting an unbound document bundle, rapidly and automatically binding said bundle quickly into a robust, cosmetically pleasing book, and delivering said book for manual dissemination or for automatic transfer to an integrated stacking and cooling column. In addition, this invention provides the capability to bind a document bundle using binder-strip having preprinted thereon a user-specified book title and/or logo such that the title or logo appears on the spine of the newly bound book.

In accordance with another preferred embodiment of the invention, there is an apparatus for accepting an unbound document bundle from an external document printer, copier or conveyor and automatically passing the bound book onward to the next step in the document finishing process.

Adding substantially to the utility and labor saving aspects of this invention, there are associated mechanisms to automate and handle the bound, completed books.

Other advantages of the present invention will become apparent from the following descriptions, taken in connection with the accompanying drawings, wherein, by way of illustration and example, embodiments of the present invention are disclosed.

### DESCRIPTION OF DRAWING FIGURES

In the drawings, closely related figures have the same number but different alphabetic suffixes.

FIG. 1A is a perspective view of the complete desktop version Binder of the preferred embodiment.

FIG. 1B is the view of FIG. 1A with the book-rest and outer body panels removed.

FIG. 1C shows the internal mechanism with right chassis side-plate 14 hidden for illustrative clarity.

FIG. 1D shows the binder's inner mechanism with left chassis side-plate 16 hidden for illustrative clarity.

FIG. 2A shows a top plan view with some parts removed for clarity.

FIG. 2B is a cross section derived from the sectioning line constructed in FIG. 2A.

FIG. 3 shows a simplified perspective view of important document handling and binding elements.

FIG. 4A is side view of the components of FIG. 3.

FIG. 4B is the view of FIG. 4A showing some assemblies moved to the next operational stage.

FIG. 4C is an enlarged detail view of a portion of FIG. 4B.

FIG. 4D is the view of FIG. 4B with the schematic addition of several driving elements.

FIG. 5A is a perspective view of a binder-tape cutter mechanism.

FIG. 5B is a broken plan view of the of the cutter mechanism of FIG. 5A.

FIG. 5C is an enlarged cross sectional view through the sliding cutter head of FIG. 5B.

FIG. 6A is a perspective view of an adhesive coated binding tape.

FIG. 6B is an enlarged detail perspective view of the edge features of FIG. 6A.

FIG. 6C is a detail end view of FIG. 6B.

FIG. 7 is a perspective view of a roll form of bulk binder-tape supply.

FIG. 8A is a perspective view of a sheet form of binder-tape supply.

FIG. 8B is an enlarged detail perspective of FIG. 8A.

FIG. 8C is an enlarged detail end view of the binder-tape and code stripe of FIG. 8B.

FIG. 9A is a view of three photo-detector arrays positioned above a support surface within the binder.

FIG. 9B is an end view of FIG. 9A of a roll form of binder-tape with a code stripe at edge offset “R”.

FIG. 9C is an end view similar to FIG. 9B except that the identifying stripe is at sheet tape location “S”.

FIG. 9D is an end view similar to FIG. 9B except that the code stripe is at print media position “P”.

FIG. 11A is a perspective view of the preferred cutter mechanism for cutting a roll of binder-tape.

FIG. 11B is an enlarged, simplified detail side view of the cutter mechanism of FIG. 11A

FIG. 12A is an end view of FIG. 4A showing the mechanism at the start of the binding process.

FIG. 12B is an end view of FIG. 4A illustrating the document clamping stage of the binding process.

FIG. 12C is an enlarged detail view of a portion of FIG. 12B.

FIG. 12D is an end view of FIG. 4A showing the mechanism at the third stage of the binding process.

FIG. 12E is an enlarged partial end view of FIG. 4A showing the roll form binder-tape feed.

FIG. 12F is an end view of FIG. 12E illustrating platen rotation to the hot platen “active” state.

FIG. 12G is an end view of FIG. 12F showing the document lowered onto the binder-tape adhesive.

FIG. 12H is an enlarged detail view of FIG. 12G wherein the binding strip is cut from the bulk roll-tape.

FIG. 12J is an end view of FIG. 12H illustrating the platens rotated into a substantially vertical position.

FIG. 12K is an end view of FIG. 12J with the partly bound book at the entry to the side seal mechanism

FIG. 12L is an enlarged detail view of FIG. 12K showing the book within the side seal mechanism

FIG. 12M is an end view showing the fully bound book retracted upward to rest on the cool platen.

FIG. 12N is an end view of FIG. 12M with the roller jaws opened for book removal.

FIG. 12P is an full end view of FIG. 12L in which the jaws open for bottom bound book exit.

FIG. 12R is an end view of FIG. 12E in which a sheet form of binder-tape is substituted for a roll form.

FIG. 13 is an enlarged partial view of the user control panel of FIG. 1A.

FIG. 14A is a perspective view of the principal elements of a “Stacker/Cooler” mechanism.

FIG. 14B is an end view of the Stacker/Cooler of FIG. 14A.

FIG. 14C is an underside plan view of the Stacker/Cooler mechanism of FIG. 14A.

FIG. 14D is an enlarged view from a different viewpoint of a portion of the Stacker/Cooler of FIG. 14A.

FIG. 14E is a side view of the Stacker/Cooler mechanism of FIG. 14A.

FIG. 14F is an enlarged partial detail section view of FIG. 14E.

FIG. 15A is a view showing the integration of the mechanisms of FIGS. 12P and 14B.

FIG. 15B is a first operational stage perspective of the mechanism of FIG. 14A with a nested book.

FIG. 15C is a view of FIG. 14B showing the second stage position in the operational sequence.

FIG. 15D is a view of FIG. 14B showing an alternate second stage position in the operational sequence.

FIG. 15E is a view of FIG. 15D showing the third stage in the operation of the Stacker/Cooler.

FIG. 16 is a schematic side view representation of the integration of the binder with a Printer/Copier.

FIG. 18A is a perspective view of sheet binder-tape with a printed spine title image.

FIG. 18B is plan view of FIG. 18A.

FIG. 19A is a perspective view of the Binder of the preferred embodiment mounted atop a desktop book stacking mechanism.

FIG. 19B is an end view of FIG. 19A with the stacker enclosure removed for clarity.

FIG. 20A is a plan view of a binder-tape code detector printed circuit board mechanism.

FIG. 20B is an end view of FIG. 20A.

FIG. 20C is an enlarged view of the contact mechanism of FIG. 20B.

FIG. 20D is a perspective view of the detector mechanism of FIG. 20A in contact with a code strip that is printed on the binder-tape.

FIG. 21A is a view of three photo-detector arrays positioned above a support surface within the binder.

FIG. 21B is the view of FIG. 21A including a roll form of binder-tape with a code stripe at edge offset R.”

FIG. 21C is the view of FIG. 21B except that the binder-tape is of sheet form and code stripe is located at edge offset “S.”

FIG. 22A is an isometric view of a binder-tape structure

FIG. 22B is a broken end view of the binder-tape structure of FIG. 22A.

FIG. 22C is an isometric detail view of the right edge of the binder-tape structure of FIG. 22A.

### REFERENCE NUMERALS IN DRAWINGS

| | | |
|---|---|---|
| 10 | Chassis baseplate | baseplate 10 |
| 12 | Chassis stiffener strongback | strongback 12 |
| 14 | Right chassis sideplate | sideplate 14 |
| 16 | Left chassis sideplate | sideplate 16 |
| 18 | Containment saddle for tape roll | saddle 18 |
| 20 | Underside book discharge opening | opening 20 |
| 22 | Static pivot axle for moving jaw | pivot 22 |
| 23 | Parallel link axle (2) | axle 23 |
| 24 | Book-rest and left justification stop | book-rest 24 |
| 25 | Book justification abutment | justification stop 25 |
| 26 | Color-pipe to view roll tape colors | colorpipe 26 |
| 28 | Access door for roll binder-tape loading | door 28 |
| 30 | Bulk binder-tape roll | rolltape 30 |
| 32 | Link arms | link arms 32 |
| 34 | Drive roller-Bookfeed | drive roller 34 |
| 36 | Slave roller-Bookfeed | slave roller 36 |
| 37 | Roller jaw assembly | jaw assembly 37 |
| 38 | Jaw actuation motor | jaw motor 38 |
| 39 | Axle bearing | bearing 39 |
| 40 | Jaw motor sprocket (schematic) | jaw sprocket 40 |
| 41 | Jaw actuation rack (schematic) | jaw rack 41 |
| 42 | Jaw actuation chain | jaw chain 42 |
| 43 | Jaw drive gear (schematic) | drive gear 43 |
| 44 | Cold platen | cold platen 44 |
| 45 | Moving support structure (schematic) | moving support 45 |
| 46 | Cold platen pivot | cold pivot 46 |
| 47 | Fixed support structure (schematic) | fixed support 47 |
| 48 | Hot platen | hot platen 48 |
| 50 | Hot platen pivot | hot pivot 50 |
| 51 | Hot platen pulley | pulley 51 |
| 52 | Hot platen heater | platen heater 52 |
| 53 | Cold platen pulley | pulley 53 |
| 54 | Hot platen insulator | insulator 54 |
| 55 | Platen motor pulley | pulley 55 |
| 56 | Hot side-seal platen - Fixed | side-seal platen 56 |
| 57 | Platen drive belt | belt 57 |
| 58 | Side-seal heater - common 2 places | side-seal heater 58 |
| 59 | Platen motor | platen motor 59 |
| 60 | Side-seal insulator - common 2 places | insulator 60 |
| 62 | Second side-seal platen - Moving | side-seal platen 62 |
| 64 | Binder-tape drive roller | tape roller 64 |
| 66 | Binder-tape nip roller | nip 66 |
| 68 | Nip roller spring | nip spring 68 |
| 69 | Tape feed gear, driven | driven gear 69 |
| 70 | Tape drive motor | tape motor 70 |
| 71 | Tape feed drive gear | drive gear 71 |
| 72 | Bookfeed motor | book motor 72 |
| 74 | Drive belt | drive belt 74 |
| 75 | Control plate extrusion | extrusion 75 |
| 76 | Tape lift finger | finger 76 |
| 77 | Spine control plate - moving | moving surface 77 |
| 78 | Spine control plate - fixed | fixed surface 78 |
| 80 | Book - Unbound document bundle | unbound book 80 |
| 82 | Book - Spine bound, side flaps flat | partially bound book 82 |
| 84 | Book - Side flaps partially formed | partially bound book 84 |
| 86 | Book - Fully bound | bound book 86 |
| 100 | Tape cutter mechanism | cutter assembly 100 |
| 101 | Sliding cutter head assembly | cutter head 101 |
| 102 | Rotary cutter blade | rotary blade 102 |
| 103 | Knife edge of cutter blade | blade edge 103 |
| 106 | Stationary tape shear blade | fixed blade 106 |
| 108 | Sharpened edge of stationary blade | sharp edge 108 |
| 110 | Guide rod for sliding cutter | guide rod 110 |
| 112 | Torsion guide rod | torsion rod 112 |
| 114 | Guide rod support - 2 places | guide bracket 114 |
| 116 | Carrier for rotary blade | blade carrier 116 |
| 118 | Torsion spring for blade loading | blade spring 118 |
| 119 | Torque pin for blade loading | torque pin 119 |
| 120 | Sliding guide sleeve bearing | sleeve bearing 120 |
| 122 | Slots for cutter drive cable | drive slots 122 |
| 123 | Cutter drive cable - Right and Left | cutter cable 123 |
| 124 | Ball bearing - rotary blade | cable fitting 125 |
| 126 | Thrust retaining ring - blade | thrust ring 126 |
| 128 | Sliding torque shoe | torque shoe 128 |
| 160 | Binder-tape with edge extrusion gap | binder tape 160 |
| 164 | Anti extrusion gap | edge gap 164 |
| 166 | Flexible binding fabric | tape fabric 166 |
| 176 | Side-seal air gap | air gap 176 |
| 178 | Lightly heated binder-strip edges | strip edge 178 |
| 180 | Binder-tape in roll format | roll tape 180 |
| 181 | Fully bound binder-strip | bound strip 181 |
| 182 | End of uncut roll-form binder-tape | uncut edge 182 |
| 183 | Cut end of roll form binder-tape | cut edge 183 |
| 184 | Adhesive edge containment zone | edge gap 184 |
| 185 | Binder-strip separated from bulk roll | cut binder-strip 185 |
| 186 | Flexible binding tape | tape 186 |
| 187 | Binder-strip partially adhered to book | binder-strip 187 |
| 188 | Support core, tape roll | core 188 |
| 189 | Tape color identifier band | color band 189 |
| 190 | User interface controls | user controls 190 |
| 192 | User display readout | user display 192 |
| 193 | Alert status LED | alert LED 193 |
| 194 | Mode status LED lights | mode LED 194 |
| 195 | Media type status LED lights | media LED 195 |
| 196 | Bind action button switch | action button 196 |
| 197 | Media select scroll button | media button 197 |
| 198 | Mode select scroll button | mode button 198 |
| 200 | Sheet format binder-tape | sheet binder-tape 200 |
| 202 | Generic adhesive | adhesive 202 |
| 204 | Code stripe “P” | code stripe 204 |
| 206 | Code stripe “R” | code stripe 206 |
| 208 | Code stripe “S” | code stripe 208 |
| 220 | Code “P” light source | light source 220 |
| 221 | Code “P” detector | detector 221 |
| 222 | Code “R” light source | light source 222 |
| 223 | Code “R” detector | detector 223 |
| 224 | Code “S” light source | light source 224 |
| 225 | Code “S” detector | detector 225 |
| 226 | Emitted light beam | light emission 226 |
| 228 | Reflected light beam | light reflection 228 |
| 230 | Support for binder and printing tapes | tape support 230 |
| 250 | Cutter assembly and partially cut tape | cutter/ |
| | | tape combination 250 |
| 252 | Binder-tape cut in progress | partial cut 252 |
| 253 | Motion vector of print transfer media | transfer feed 253 |
| 254 | Motion vector of cutter head | cutter motion 254 |
| 255 | Motion vector of rolltape feed | feed vector 255 |
| 256 | Motion vector of document bundle | bundle motion 256 |
| 257 | Motion vectors of platen rotation | platen vector 257 |
| 258 | Motion vector of roller jaw open/close | jaw motion 258 |
| 259 | Motion vector of sheet fed binder-tape | sheet feed 259 |
| 260 | Manual media feed chute | feed chute 260 |
| 300 | Stacker/Cooler mechanism | Stacker/Cooler 300 |
| 302 | Side support plate, right | support plate 302 |
| 303 | Side support plate, left | support plate 303 |
| 304 | Chute pivot bearing (2) | pivot bearing 304 |
| 306 | Chute pivot shaft (2) | pivot shaft 306 |
| 307 | Channel slide bearing (2) | channel bearing 307 |
| 308 | Chute pivot motor | pivot motor 308 |
| 310 | Pivot drive pulley | drive pulley 310 |
| 312 | Pivot drive belt | drive belt 312 |
| 314 | Pivot driven pulley | driven pulley 314 |
| 316 | Side chute plate, right | chute side 316 |
| 318 | Side chute plate, left | chute side 318 |
| 320 | Spine plate, chute | spine plate 320 |
| 322 | Book capture channel, right | capture channel 322 |
| 324 | Book capture channel, left | capture channel 324 |
| 325 | Channel motion vector | motion vector 325 |
| 326 | Channel slide bellcrank | bellcrank 326 |
| 328 | Bellcrank bearing | bellcrank bearing 328 |
| 330 | Bellcrank link (2) | bellcrank link 330 |
| 332 | Bellcrank link pivot (2) | link pivot 332 |
| 334 | Pivot, channel link | channel pivot 334 |
| 336 | Cam for closing chute | cam 336 |
| 340 | Channel pull solenoid | solenoid 340 |
| 342 | Channel pull solenoid plunger | solenoid plunger 342 |
| 344 | Actuation cap, plunger | plunger cap 344 |
| 346 | Connector disk, solenoid to channel | connector disk 346 |
| 348 | Notch, connector disk (2) | disk notch 348 |
| 350 | Rotation vector, yoke/chute | rotation vector 350 |
| 352 | Book transfer motion vector | transfer vector 352 |
| 354 | Book drop motion vector | drop vector 354 |
| 356 | Book stack, staggered | book stack 356 |
| 358 | Cart, book | book cart 358 |
| 400 | Binder, horizontal orientation | horizontal binder 400 |
| 402 | Printer or copier | printer/copier 402 |
| 404 | Binder infeed conveyor | infeed conveyor 404 |
| 406 | Binder outfeed conveyor | outfeed conveyor 406 |
| 408 | Book horizontal infeed vector | infeed vector 408 |
| 410 | Book horizontal outfeed | outfeed vector 410 |
| 520 | Sheet Binder-tape | sheet binder-tape 520 |
| 522 | Fabric Side | fabric side 522 |
| 524 | Insertion Edge | insertion edge 524 |
| 526 | Generic Spine Title | spine title 526 |
| 540 | Binder Mechanism | binder 540 |
| 550 | Ballistic Stacker | ballistic stacker 550 |
| 552 | Ballistic Stacker Enclosure | enclosure 552 |
| 554 | Bound Book | bound book 554 |
| 556 | Book Stack | book stack 556 |
| 558 | Guide Chute | chute 558 |
| 560 | Book Basket | hinged basket 560 |
| 562 | Basket pivot | basket pivot 562 |
| 564 | Extension Spring | extension spring 564 |
| 580 | Conductive Detector Assembly | detector assembly 580 |
| 582 | Detector Circuit Board | circuit board 582 |
| 584 | Long Contact Arm | long arm 584 |
| 586 | Short Contact Arm | short arm 586 |
| 588 | Long Contact Bump | long contact 588 |
| 590 | Short Contact Bump | short contact 590 |
| 592 | Conductive Code Stripe | conductive stripe 592 |
| 620 | Ultraviolet (UV) | UV diode 620 |
| | emitting diode - Channel “S” | |
| 622 | Ultraviolet (UV) | UV diode 622 |
| | emitting diode - Channel “R” | |
| 624 | Ultraviolet (UV) emitting diode | UV diode 624 |
| 621 | Photo detector - Channel “P” | detector 621 |
| 623 | Photo detector - Channel “R” | detector 623 |
| 625 | Photo detector - Channel “S” | detector 625 |
| 626 | UV radiation vector | UV vector 626 |
| 628 | Reflected UV light | reflected UV 628 |
| 629 | Optical UV filter | UV filter 629 |
| 630 | Binder-tape support plate | binder-tape support 630 |
| 640 | Roll form binder-tape | roll binder-tape 640 |
| 642 | Sheet form binder-tape | sheet binder-tape 642 |
| 650 | Fluorescent stripe at “R | fluorescent stripe 650 |
| 652 | Fluorescent stripe at “S” | fluorescent stripe 652 |
| 660 | UV and Fluorescence radiation vector | combined radiation 660 |
| 662 | Filtered fluorescent radiation | filtered radiation 662 |
| 700 | Binder-tape assembly | binder-tape 700 |
| 702 | Flexible binding fabric | tape fabric 702 |
| 704 | Generic adhesive | adhesive 704 |
| 706 | Left adhesive edge gap | left gap 706 |
| 707 | Left adhesive band | left adhesive band 707 |
| 708 | Right adhesive edge gap | right gap 708 |
| 709 | Right adhesive band | right adhesive band 709 |
| 710 | Left adhesive extrusion ditch | left ditch 710 |
| 712 | Right adhesive extrusion ditch | right ditch 712 |
| 714 | Adhesive code gap | code gap 714 |
| 716 | Code stripe | code stripe 716 |

### DESCRIPTION

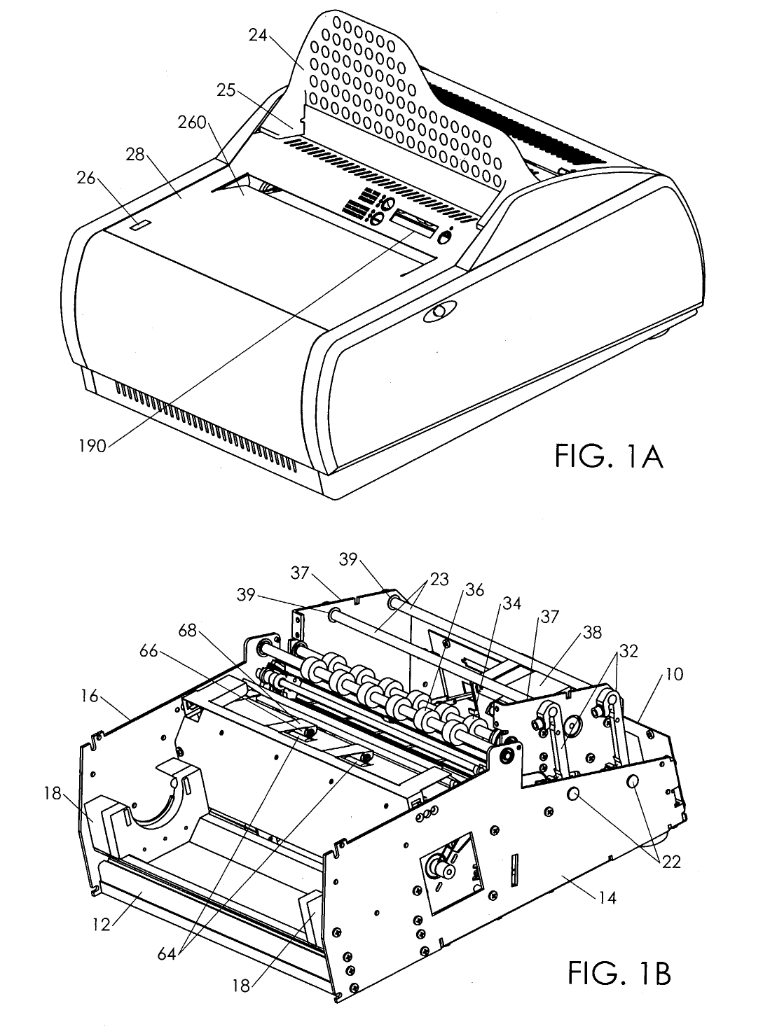

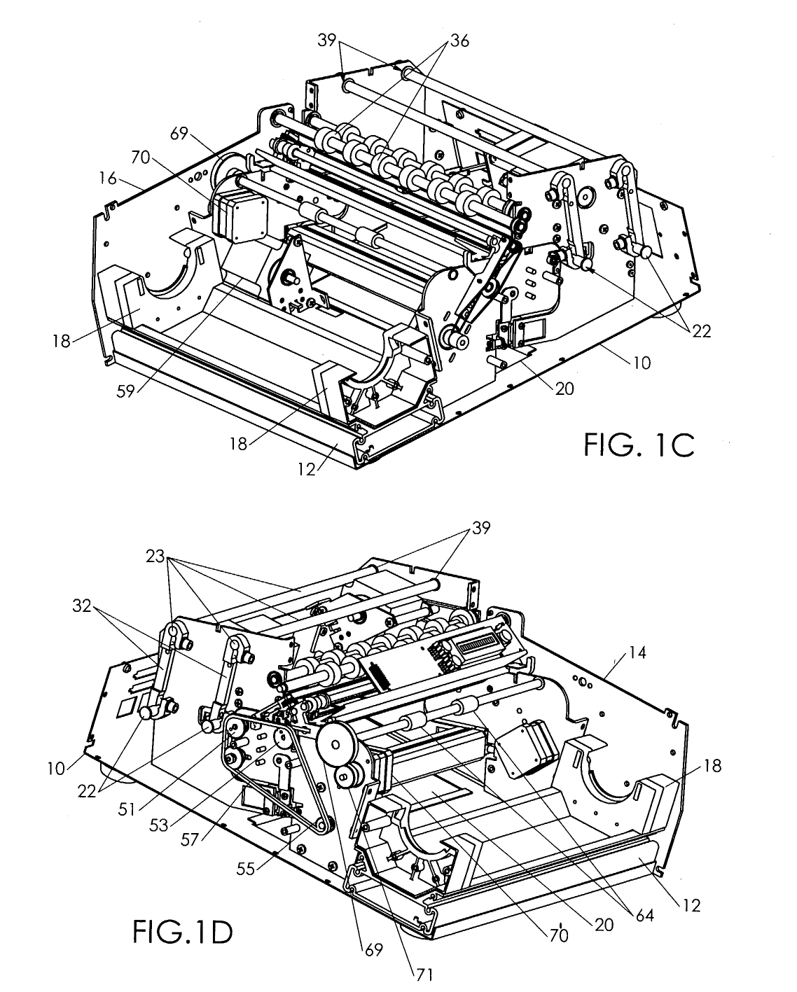

### FIGS. 1-5—Preferred Embodiment—Binder

A detailed description of the preferred embodiments is provided herein. However, the present invention may be embodied in various forms. Specific details disclosed herein are not to be interpreted as limiting, but rather as a basis for claims and as a representative basis for teaching.

Turning to FIG. 1A, a perspective view is shown of an apparatus for tape binding the spine of a document bundle. The overall size of the preferred embodiment of the apparatus is approximately 18 inches by 18 inches in plan view and is about 11 inches in overall height. The device is shown with the enclosure panels in place in the manner in which a user would encounter the device when situated atop a desk or worktable. A door or hinged cover 28 is provided for access to load bulk binding tape into the binder. The bulk binder-tape will be introduced later. A window or color pipe 26 is an optic light pipe enabling the user to discern the color of the loaded binder-tape. A book-rest 24 provides an angled surface against which the unbound document bundle will rest. A protruding abutment on the left side of book-rest 24 acts as a justification stop 25 against which the unbound document bundle, not shown, is justified left before binding.

As can be observed in FIG. 1A no side openings are required, because of the internal binder-tape storage, for the insertion, or loading, of a manually fed binder-strip. Prior art binders require a side opening for the side feeding of binder strips up to 15 inches long. Thus the desk or floor space consumed by such binders is actually up to 15 inches wider that the binder itself. For example, a binder marketed by Powis-Parker, is about 25 inches wide and requires up to 15 inches additional side clearance for a total desk space of approximately 40 inches. The width of the binder of the preferred embodiment of this invention is about 19 inches. Therefore, two binders according to this invention could easily fit in the space required the single binder just mentioned. Further space saving is achieved when considering the Powis-Parker spine printer which normally sits alongside their binder. The invention of this disclosure is fully contained for internal binder-tape feeding as well as spine printing within the approximate 19×19 (inch) desktop footprint.

The illustration of FIG. 1B is the device of FIG. 1A with the enclosure covers and door 28 removed to expose some of the interior details. The binder is constructed about fixed chassis parts consisting of a baseplate 10, a strongback 12 and sideplates 14 and 16. The two identical opposed nests or saddles 18, are utilized to support a roll of bulk binder-tape (not shown). The free end of the (to be introduced) roll form binder-tape will be shown to be pinched between a tape roller 64 and a nip 66 by the force of a nip spring 68 for the purpose of feeding the binder-tape into position for book binding.

Opposed roller jaws consisting of a movable drive roller 34 and a fixed slave roller 36, shown in FIGS. 1B, 1C and 1D, grasp and move the unbound and bound book through the various stages of binding and printing. The roller jaw system of drive roller 34 and driven roller 36 is supported by a jaw assembly 37 which is opened and closed by a jaw motor 38 acting through a suitable driving mechanism. See FIG. 1C. The motion of jaw assembly 37 is constrained and controlled by a quartet of parallel link arms 32 pivoted at each end about a pair of transverse axles 23. Each link-arm 32 pivots at a non-translating or fixed end about a pivot 22. The translating end of each link arm 32 is rigidly attached to one end of one of axles 23. This rigid attachment maintains the right sides of link arms 32 in synchronous relation with the left-hand set of link arms 32. The ends of axles 23 pivot freely within bearings 39 attached to jaw assembly 37. Thus the preferred embodiment of the jaw assembly 37 forms a reliable and robust, low friction alternative to other, more expensive mechanisms such as linear slides or ball bushing slide sets.

Referring to FIGS. 1C and 1D an underside book discharge exit is provided by a opening 20 for use when the binder is mounted atop a Stacker/Cooler mechanism or when adapted to automation products where a “straight through” book flow path is desirable. Also depicted in FIG. 1D are the rotary drive combination of a pulley 55, a belt 57, a pulley 51 and a pulley 53. This grouping of parts will be shown to effect the synchronous rotation of the hot and cold platens. These platens are not shown in this view and have not yet been introduced. The function of the platens and their rotation will be described later.

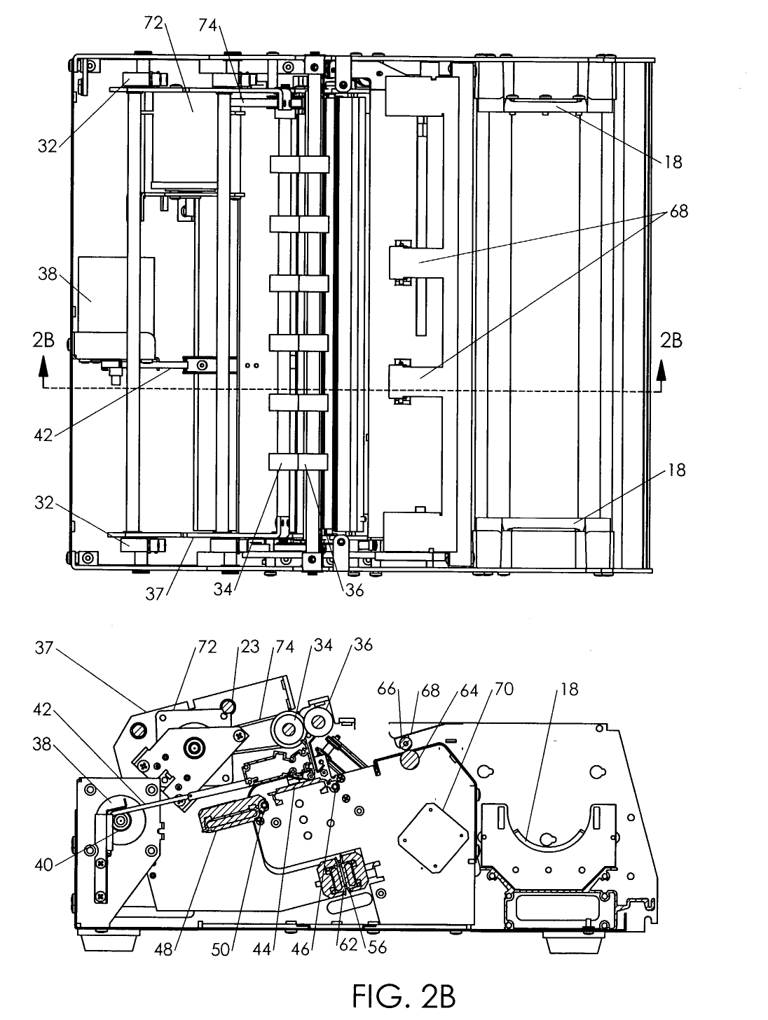

The feeding of the roll form of-the bulk binder-tape is shown in FIG. 1D. Roll tape feed is accomplished by the combination of a tape motor 70, a drive gear 71 and a driven gear 69 rotationally driving a tape roller 64. Jumping forward to FIG. 2B, the relationship of tape roller 64, nip 66, and nip spring 68 are shown. The binder-tape (not shown in FIG. 2B) is pinched between tape roller 64 and nip 66 by nip spring 68. Thus rotation of tape motor 70 will cause linear translation of a binder-tape between tape rollers 64 and nips 66. The binder-tape in its various forms will be introduced later in the discussion.

Roller jaw assembly 37 is positioned by a jaw motor 38 and a jaw sprocket 40 acting upon a jaw chain 42 as seen in the closed jaws configuration of FIG. 2A and FIG. 2B. The anti-clockwise rotation of jaw motor 38 causes jaw assembly 37 to open, allowing insertion of an unbound book 80 which is not shown. When jaw motor 38 is commanded to rotate clockwise jaw assembly 37 closes and clamps unbound book 80 between drive roller 34 and slave roller 36.

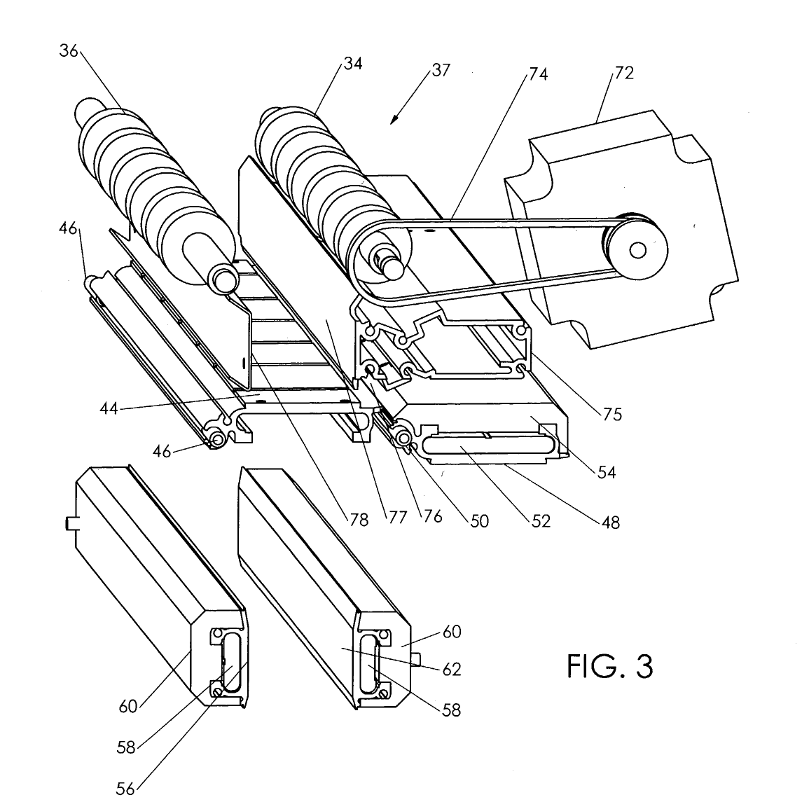

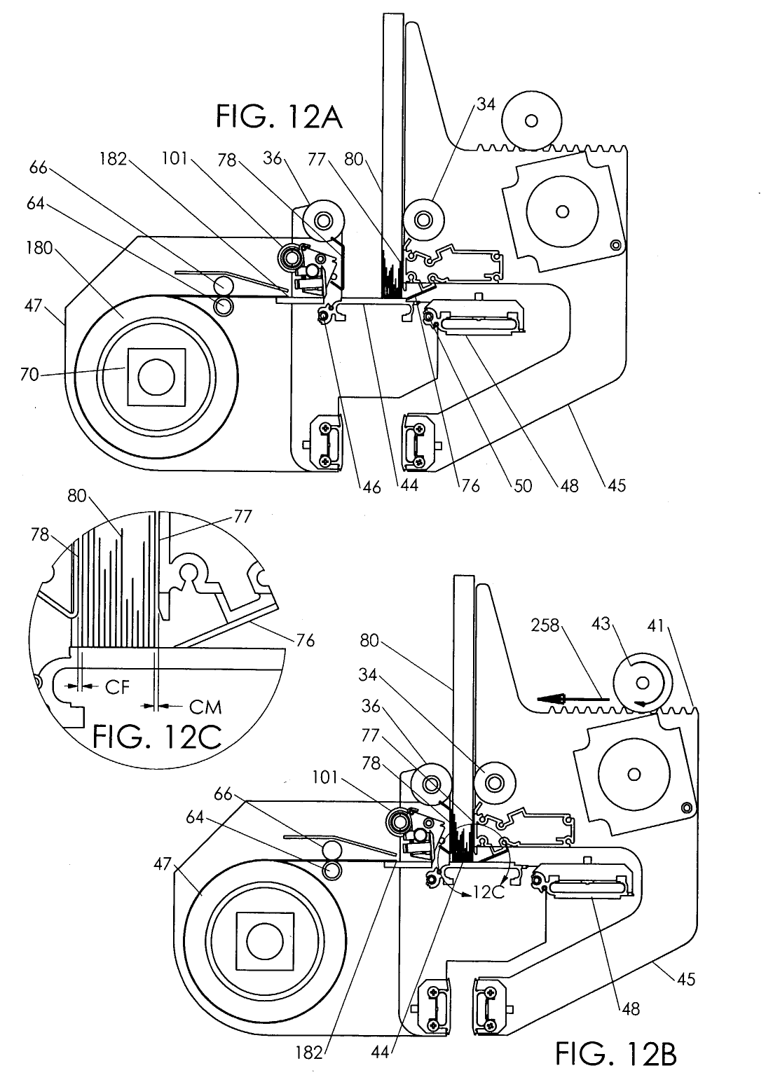

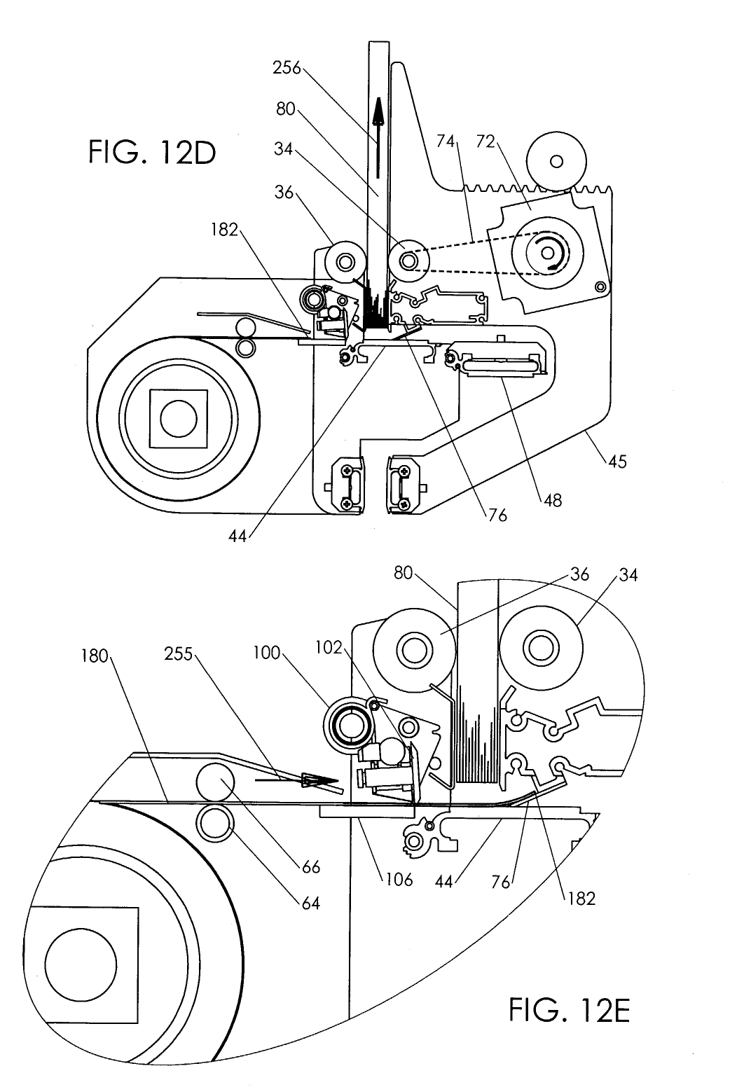

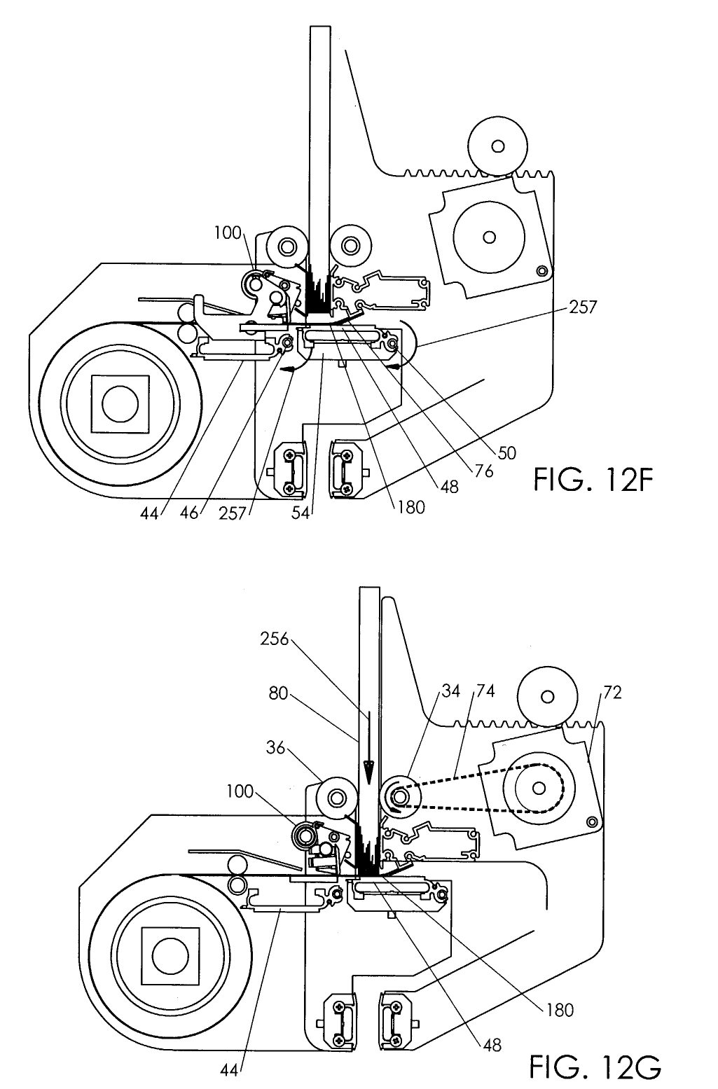

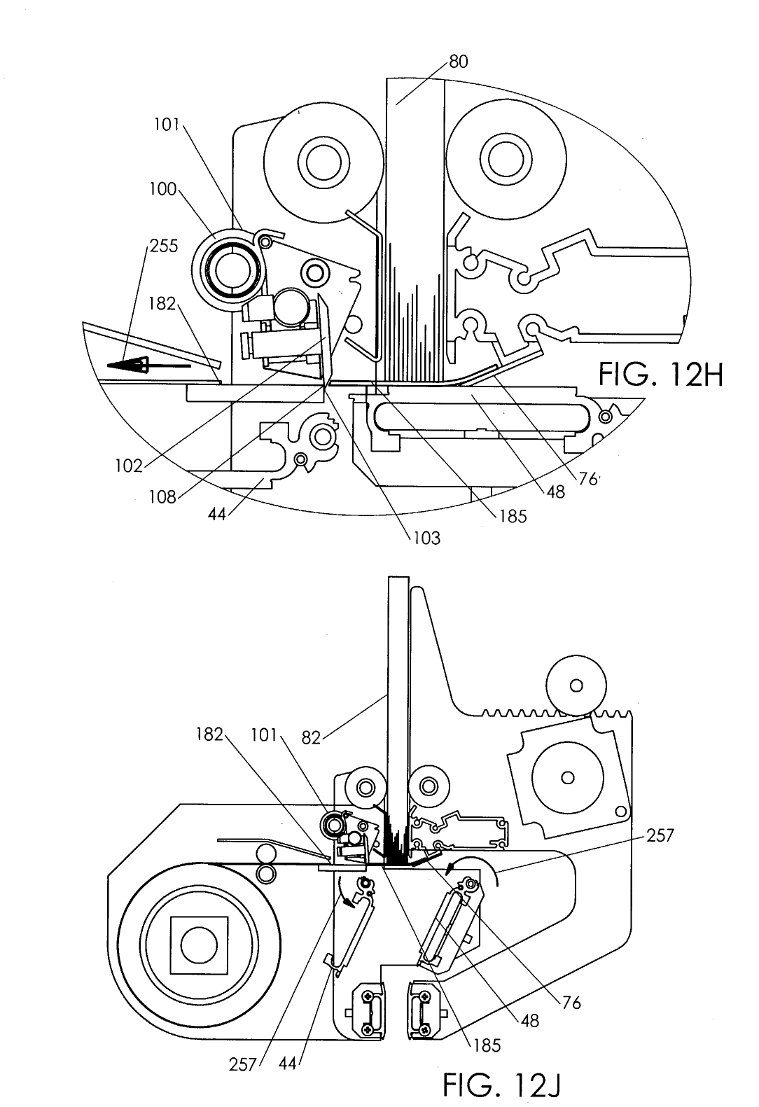

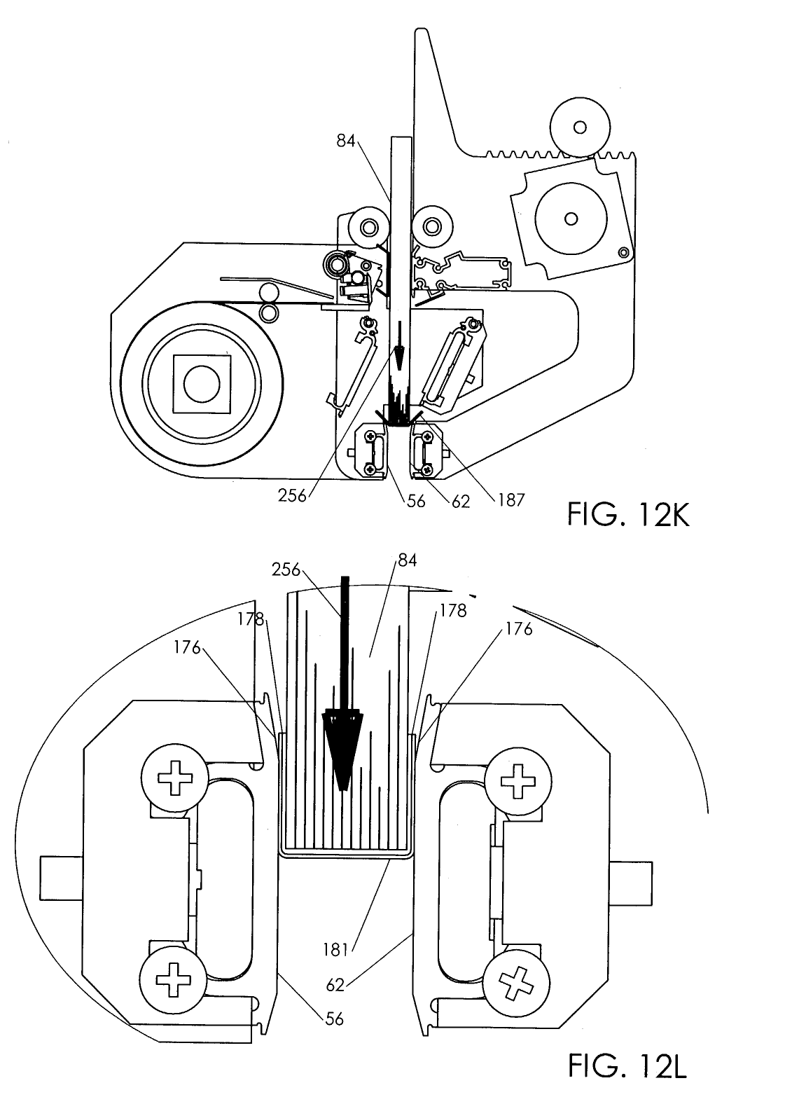

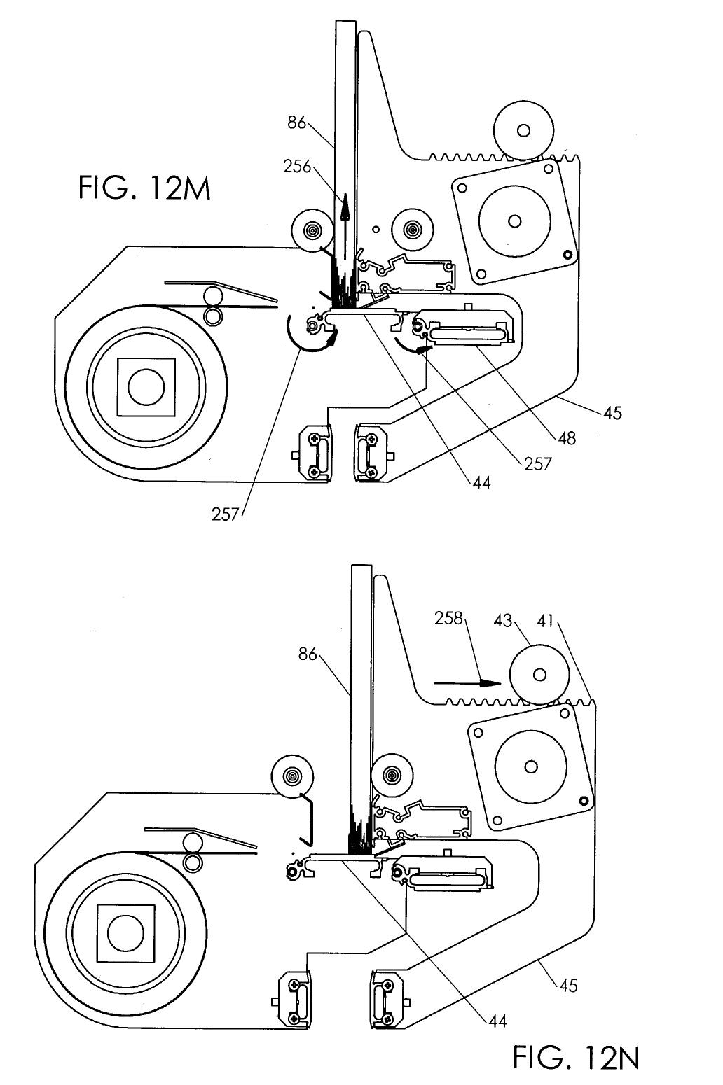

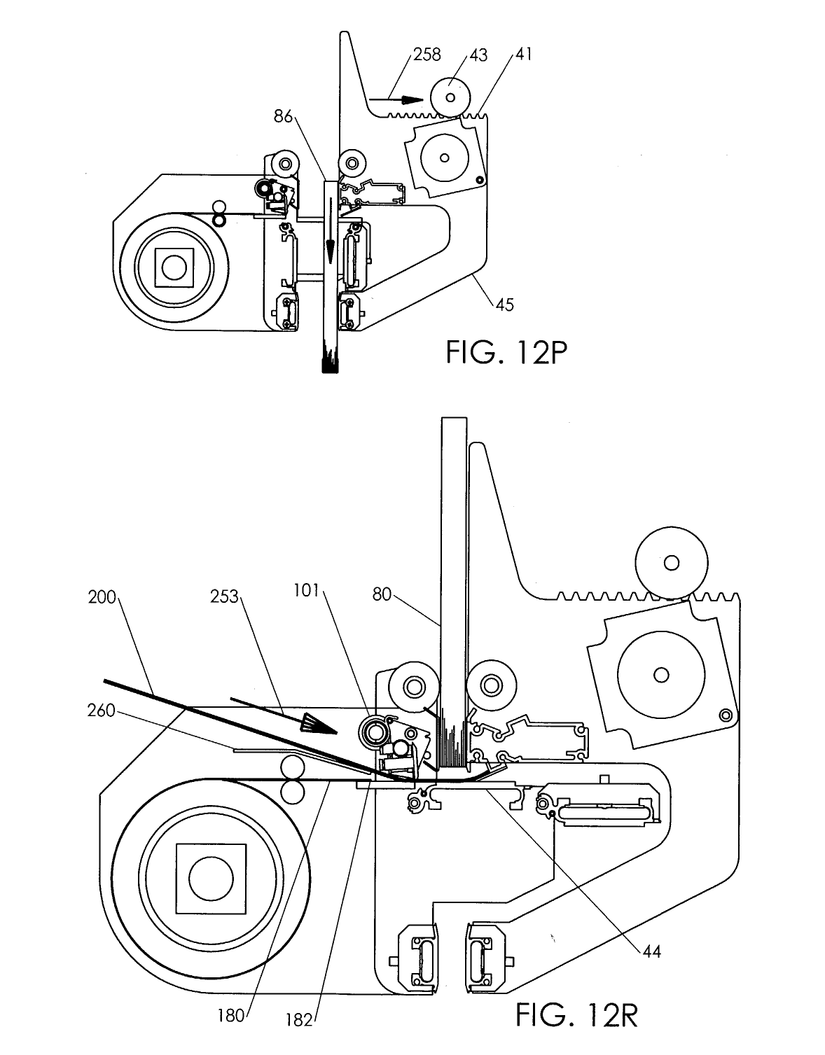

A preferred book drive system of FIG. 2A consists of a book motor 72 and a drive belt 74 acting to rotate drive roller 34. Slave roller 36 is a passive roller shaft supported by anti-friction bearings at each end. Thus the clockwise rotation of book motor 72 will cause book 80, not shown, to be positioned downward while an anti-clockwise rotation will lift unbound book 80. The relationship of the above elements might be more clearly understood by referring to FIG. 3 and FIG. 12D.

Several preferred concepts for the heating and melting and cooling of the hot melt adhesives coating the binder-tape are first introduced in FIG. 2B. A cold platen 44 is horizontally disposed underneath the jaw combination of drive roller 34 and driven roller 36 which are shown in the “jaws closed” condition. Thus, as will be shown later, when the roller jaw system is opened and the document bundle inserted, the edge, or spine, to be bound will rest upon the surface of cold platen 44. Cold platen 44 is supported at both ends by bearings constraining a pair of cold platen pivots 46. The construction of these items, less the bearings, is perhaps more easily understood by referring to FIG. 3 in which roller jaw assembly 37 is shown in the “open jaws position. The mechanism of the preferred embodiment used to melt the binder-tape is a hot platen 48 which is also horizontal but shown here with its active, or hot surface facing downwards away from the book spine. Hot platen 48, is supported at both ends by a pair of hot platen pivots 50. Nested within the confines of hot platen 48 lies an electrical platen heater 52. The preferred platen heater 52 element shown is an industry standard resistive device known as a “strip heater” which is particularly adaptable to this preferred embodiment in that it provides a large heat flux evenly distributed over a large surface area. It is possible to integrate other types and configurations of electrical heaters as would other methods of heating such as induction heating, ultrasonic heating or radiant energy. In other words, any method to deliver heat to a surface or directly to the binder-tape adhesive would be acceptable in this invention.

Also illustrated in FIG. 2B and FIG. 3 is an opposed set of heating elements and platens composed of a side-seal platen 56 and a second side-seal platen 62. As in the case of the spine heating system side-seal platen 56 and second side-seal platen 62 each contain a side-seal heater 58. Side-seal heaters 58 are of the same type as spine heater 52. In the preferred embodiment, however, the physical size and wattage rating differs. As mentioned before, any type of suitable, functional heater elements may be substituted. Side-seal platen 56 assembly is fixedly mounted to the binder chassis. The second side-seal platen 62 is attached to, and opens and closes with jaw assembly 37. The illustration of FIG. 3 shows the side-seal elements in the “jaws open” condition while FIG. 2B shows the jaws closed. Observe that when the jaws are closed, as in FIG. 2B, the active surfaces of side-seal platen 56 and the second side-seal platen 62 are touching. This is an important feature of the energy saving efficiency of this invention in that radiation and convection losses from the side-seal heaters is dramatically reduced during idle periods when the roller jaw system is closed. As a further aid to energy savings and efficiency the preferred embodiment utilizes the enveloping low heat loss characteristics of a pair of side-seal insulators 60 and the similarly intended hot platen insulator 54. In the preferred embodiment the most effective material for these insulator blankets is a “foam-in-place” silicone rubber. Silicone provides the necessary heat resistance up to about 225 degrees Celsius. It is possible to obtain closed cell foam in the range of 5 to 10 pounds per cubic foot when using foam-in-place. These foamed materials have very good insulation properties. Alternatively, a silicone foam extrusion is a lower cost alternative at the expense of a lower insulating value. Other insulating material or no insulator at all is also viable and does not affect the operation of the binder except in terms of energy savings, energy efficiency and warm-up delays. Most existing tape binders pay scant attention to heat loss and energy management.

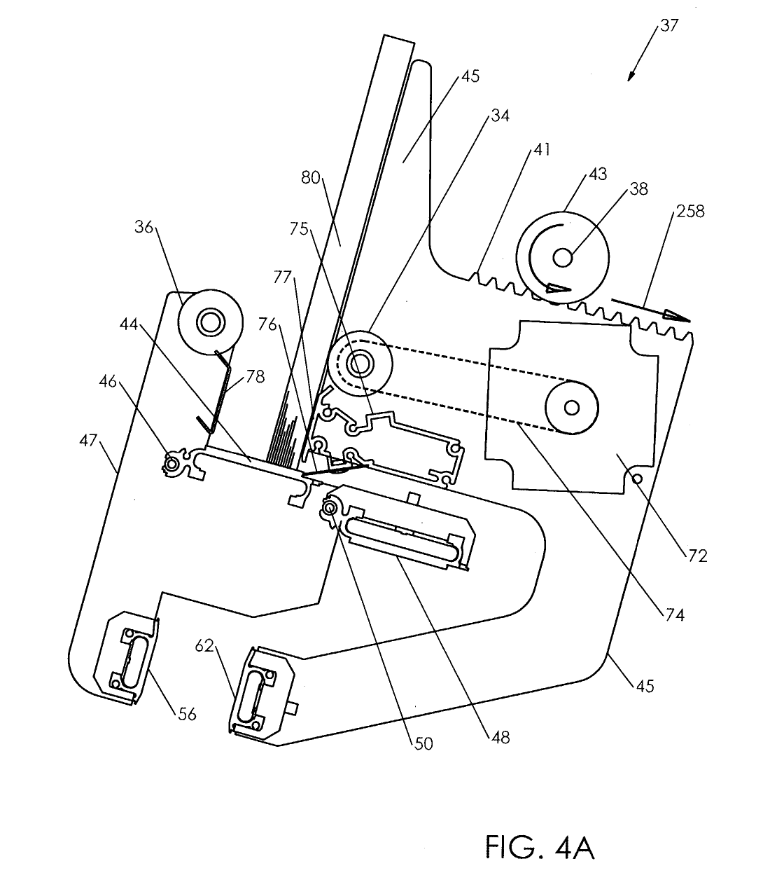

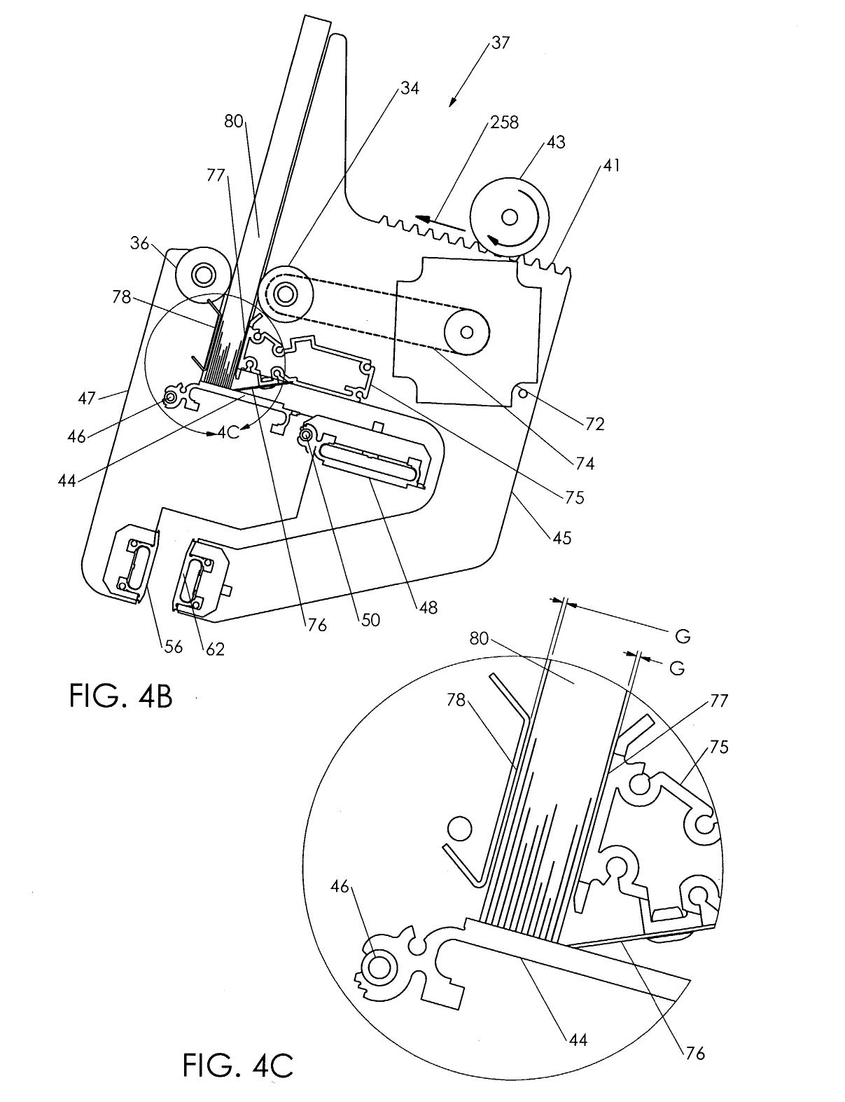

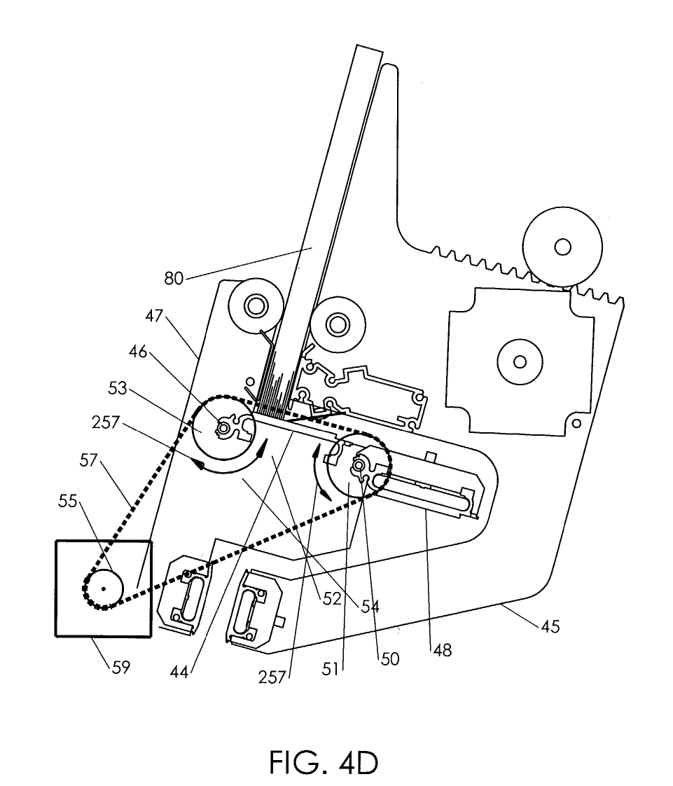

A pair of opposing surfaces is shown in FIG. 3. A vertical fixed surface 78 lies in opposition to a moving surface 77. Referring to FIGS. 4B and 4C, it may be seen that the spacing between moving surface 77 and fixed surface 78 is slightly greater than the spacing between drive roller 34 and slave roller 36. Drive roller 34 is inset from moving surface 77 a dimensional amount “G” and slave roller 36 is inset the same dimensional amount “G” from fixed surface 78. In this manner when unbound book 80 is gripped between drive roller 34 and driven roller 36, dimensions “G” are maintained so that there is little or no resistance to upward or downward movement of the book when the jaw roller drive is activated. The purpose of the opposing walls of moving surface 77 and fixed surface 78 is to control the allowable book space or, in other words, to control page spacing at the interface of the document bundle and the binder-tape adhesive. It is very desirable not to pinch the page edges during binding. For an effective bind of maximum strength a small space must be available between pages for a small amount of adhesive to “wick” a distance up and into the page gaps. The insets “G” allow the pages to spread just enough to effect proper wicking.

Turning now to FIG. 4A, a few new items will be introduced and explained. This illustration has been simplified in a manner conducive to teaching about the operation of the invention and the function of the components and systems. A first alternate embodiment of the invention substitutes a motor and rack arrangement for jaw motor 38, jaw sprocket 40 and jaw chain 42. Schematically substituting for those three drive elements are a drive gear 43 and a jaw rack 4. The means for moving the roller jaw system is irrelevant to the invention and a myriad of concepts are well known to anyone skilled in the art. A second embodiment eliminates any means of controlling guidance of the moving jaw system. The preferred embodiment utilizes the previously discussed parallel linkage method for guidance.

The illustration of FIG. 4A illustrates jaw assembly 37 being opened up in the direction of jaw motion vector 258 by the anti-clockwise rotation of drive gear 43 which is driven by jaw motor 38. This method of driving jaw assembly 37 open and closed will be repeated throughout the discussion and no further detailed discussion will be presented as to how the motions are derived. This figure clearly illustrates that fixed support 47 supports all the elements not subject to jaw movement.

The spine of unbound book 80 is shown in FIG. 4A resting on the surface of cold platen 44. The roller jaws have been opened in response to the interruption by unbound book 80 of an optical beam in the preferred embodiment. The optic beam system is not shown. Other “book presence” detectors, within the spirit of the invention might be a mechanical switch or a manual, user generated, switch actuation.

Referring now to FIG. 4B and FIG. 4C, it will be seen that moving jaw assembly 37 has been closed with unbound book 80 being firmly grasped between drive roller 34 and slave roller 36. Note that the side-seal heater group consisting of first side-seal platen 56 and second side-seal platen 62 now has a space between them approximately equal to the book thickness. In the preferred embodiment the space is slightly greater that the book thickness to allow for the added thickness of the binder-tape as it wraps up along the front and rear covers. Also the actual side-seal mechanism utilizes a spring-loaded compliance to allow for the several variations and tolerances which inevitably exist. The compliant mounting of side-seal platen 56 is not shown and many methods of spring mounting are available to anyone skilled in the art.

A finger 76 is shown, most clearly, in FIG. 4C. This element consists of, in the reality of the embodiment, six fingers disposed along the length of the platens. The fingers are supported by attachment means to the underside of an extrusion 75, which in the preferred embodiment is a convoluted structure that has as its front face moving surface 77. The exact number of these fingers is not important, merely that there are a number of them disposed the full length of the platens. The purpose of fingers 76 will be described later.

Referring to FIG. 4D, the manner in which the preferred embodiment controls the aforementioned platen positions as required in the operation of the binder is illustrated. The platen drive system consists of platen motor 59 with pulley 55 affixed to its output shaft. Pulley 55 in turn engages belt 57 that drives pulley 53 rotationally keyed to cold platen 44 rotating about cold pivot 46. Belt 57 also synchronously drives pulley 51 that is similarly keyed to hot platen 48 rotating about hot pivot 50. Suitable limit sensing switches, not shown, give homing information to a controller for platen motor 59. Thus, when platen motor 59 revolves anti-clockwise cold platen 44 moves toward the “active” position disposed underneath the spine of unbound book 80. When platen motor 59 rotates clockwise the system rotates hot platen 48 into the “active” position. This mechanism also lends itself to “jogging” the book page edges by the rapid oscillation of cold platen 44. The preferred embodiment uses a chain drive to accomplish the above. It is easily understood that there are many mechanisms that are able to perform the described functions. Indeed, although the rotary motion configuration mentioned has much to recommend it, it is understood that other forms of linear or other motions and mechanisms might work well. The only need is for the key elements of the positioning of cold platen 44 and hot platen 48 to be in their respective proper locations at the various stages of the binding cycle.

At this point in the discussion all the principal functions of the roller jaw systems have been described and discussed. The sequence of events connecting these elements and their motions will be described below. For the moment the discussion will move to other key elements of the invention.

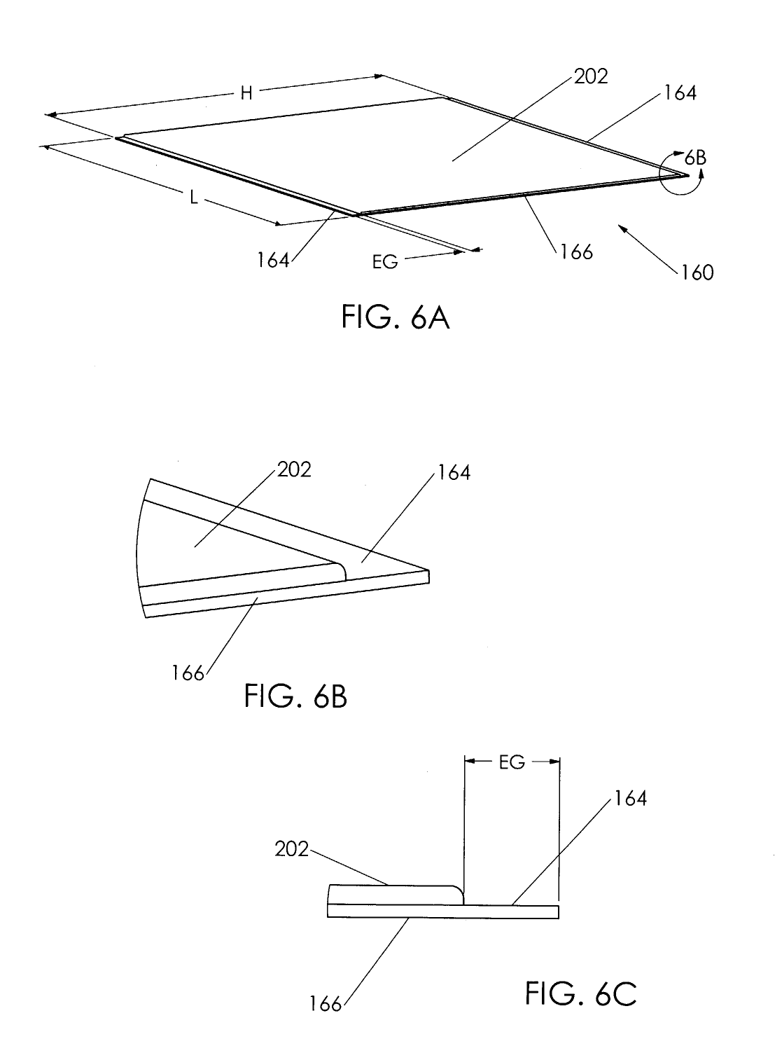

### FIGS. 6-11—Additional Embodiments

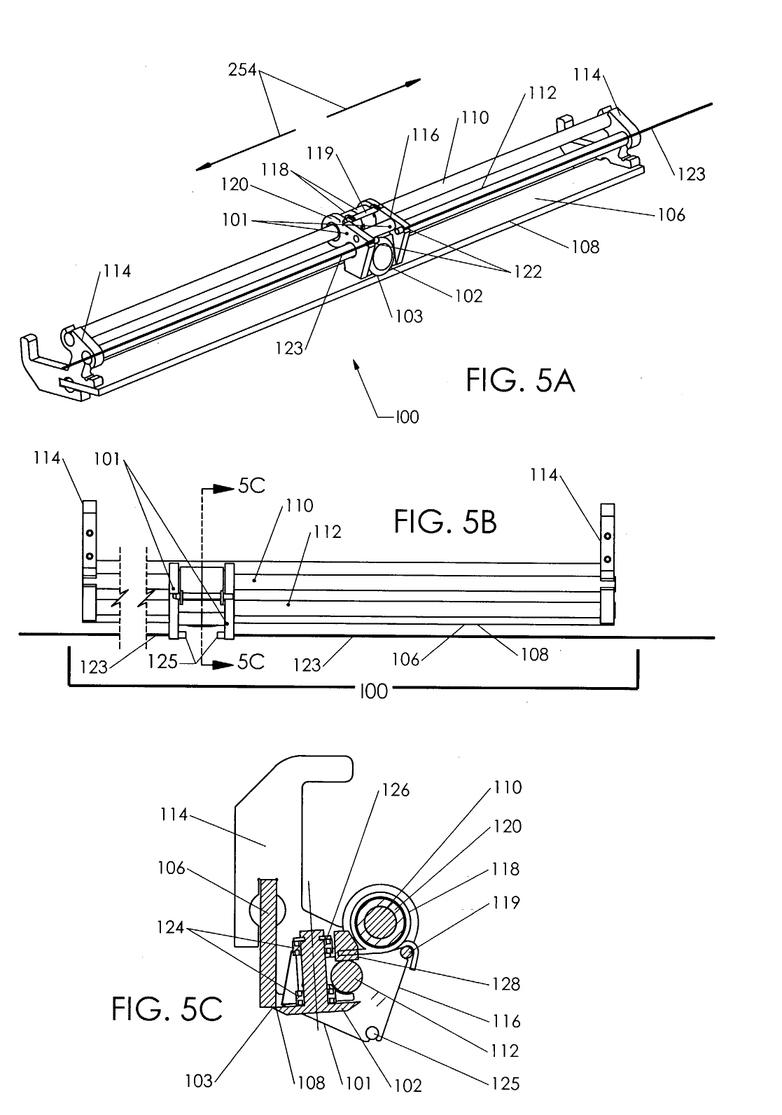

Refer now to FIG. 5A that illustrates a tape-cutter assembly 100 for slicing bulk binder-tape into the correct width of strip for binding. The preferred embodiment is formed of a cutter head 101 that has, as a component, a rotary blade 102. Cutter head 101 is caused to slide transversely along a guide rod 110 by the pulling action of a cutter cable 123. The mechanism activating the cable, not shown in this application, is a simple endless cable wrapped around a motor driven capstan. When the capstan drives in one direction cutter cable 123 pulls cutter head 101 to one extreme of cutter assembly 100. Capstan rotation in the other direction pulls cutter head 101 to the other extreme. The arrows of cutter motion vector 254 shows the directions of motion of cutter head 101. Suitable limit sensing devices signal the capstan rotation to cease. Alternative mechanisms to drive cutter head 101, such as rack and pinion or lead screws, are other possible embodiments.

The cutting action of cutter assembly 100 is by a rotary shearing action caused by a sharpened blade edge 103 shearing against a sharp edge 108 of a long transverse fixed blade 106. A non-rotating sharpened blade could be substituted for rotary blade 102 at a lower cost but the vastly improved service life of the rotary style of cutter was selected for the preferred embodiment. Indeed, there are several styles of paper cutter such as guillotines, laser, hot wire that might work in this invention. The actual type of cutter mechanism employed is irrelevant to the novelty of this invention.

Referring to the three drawings FIGS. 5A, 5B and 5C it will be seen that two guide brackets 114 are disposed and attached at the ends of the fixed blade 106. The pair of guide brackets 114 grip and position fixed blade 106, guide rod 110 and a torsion rod 112. Rotary blade 102 is suspended in cutter head 101 by a ball bearing 124 pair and is axially constrained by a thrust ring 126 in a groove in the bearing shaft portion of rotary blade 102. The pair of ball bearings 124 is nested in receptacles in a housing, blade carrier 116. Gripped within the wings of blade carrier 116 is a sleeve bearing 120 that surrounds guide rod 110 permitting precise transverse movement of cutter head 101. Around the outside of sleeve bearing 120 exists a right-hand and a left-hand blade spring 118. One bent end of each blade spring 118 engages a torque pin 119 pin attached to blade carrier 116. The other, straight, end of each blade spring 118 terminates in a pocket or hole in a torque shoe 128. In turn torque shoe 128 bears against torsion rod 112 running the length of the cutter mechanism. Referring particularly to FIG. 5C, the effect of this blade spring 118 pair and its associated torque shoe 128 is that cutter head 101 is placed under a clockwise torsional moment about guide rod 110. Said torsional moment causes the flat inside surface of rotary blade 102 to bear, under load, against sharp edge 108 of fixed blade 106. The positioning of the various elements is such as to ensure that blade edge 103 of rotary blade 102 is in mutual knife-edge contact with sharp edge 108 of fixed blade 106. When cutter head 101 is driven along guide rod 110 the contact pressure of rotary blade 102 against sharp edge 108 will cause rotary blade 102 to rotate. This blade rotation creates a very efficient shearing, or cutting, action. The construction of this preferred embodiment ensures a very clean cut in binder-tape materials and operates smoothly and reliably with a long life when used for cutting these somewhat abrasive materials. A clean cut is essential because if the binder-tape is not cleanly parted, the cutter blades can easily gum up with adhesive. Again, other methods are possible but this embodiment is preferred. A pair of cable fittings 125 shown in FIGS. 5B and 5C are attachments at the two ends of a cutter cable 123 which engages drive slots 122 in cutter head 101. The integration of the mechanism of cutter assembly 100 will be left to an appropriate place in the sequence of operation.

The illustrations of FIGS. 6A, 6B and 6C introduce an embodiment of the binder-tape. The construction shown is for information only in that the concepts and methodology are in the public domain and well described in the Watson U.S. Pat. No. 3,847,718 issued in 1974. As shown in FIG. 6A a binder-tape 160 is in the form of a flat sheet of width “H” and indeterminate length “L”. Binder-tape 160 is composed of a tape fabric 166 with an over-coating of adhesive 202 laminated on its top surface. Adhesive 202 is, for the purposes of the present invention, a “hot melt” adhesive. The composition and details of construction of the adhesive are not addressed in this disclosure, as many different embodiments of the adhesive/fabric are candidates for use in this invention. For two reasons there is an edge gap 164 of dimension “EG” at the sides of the long edges “L”. The first reason for edge gap 164 is that it can aid in the prevention of hot, fluid adhesive from extruding out the sides which can contaminate the mechanism in the binder and can also create an unsightly deposit on the outside of the finished book. The second reason is that the use of edge gap 164 in the production of binder-tape 160 permits a less difficult and thus less costly process of production. Coating tape fabric 166 directly up to the edge presents production problems. However, this is not to say that a binder-tape without an edge gap will not operate in the present invention; indeed it will. The width “EG” of the edge gap 164 is also non-specific although it is found that a dimension of about 0.080 to 0.120 inches (2 mm to 3 mm) works well.

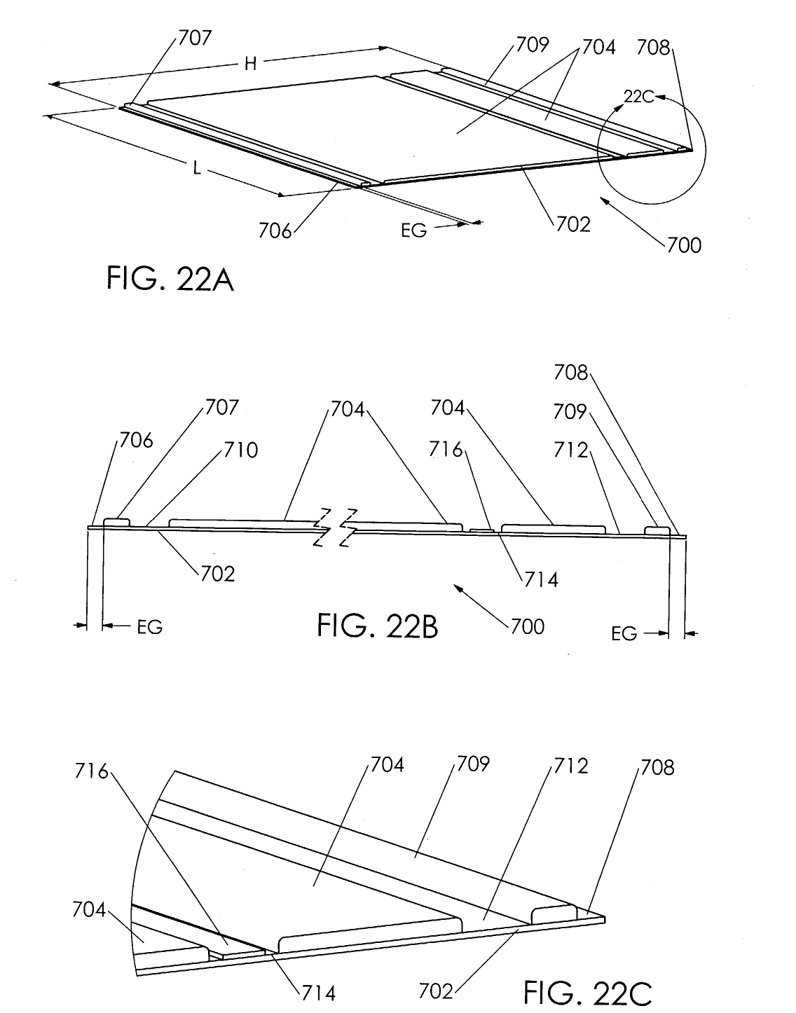

### FIGS. 22A/B/C—Binder-Tape Structure Enhancements

FIG. 22A illustrates a section of binder-tape of length “L” and width “H” where “H” equates to a book's top to bottom dimension. The binder-tape is a sandwich structure consisting of a tape fabric 702 adhered to which is a layer of adhesive 704. Various discontinuities in adhesive 704 are seen to be present, two of which are shown at left gap 706 and right gap 708. Other breaks in the adhesive layer will be described later.

Right and left gaps 706 and 708 are dimensioned “EG” to mitigate the extrusion of hot, low viscosity adhesive from the top and bottom book edges during the binding process.

From the standpoint of extrusion mitigation, the dimension “EG” should be as large as conservatively required to absorb any possible extrusion from the full width of the binder-tape adhesive. The negative effect of having a wide gap “EG” is that it-may leave edge portions of tape fabric 702 not adhered to the spine or covers. This lack of adhesion provides an edge or flap that may be easily “snagged” or pulled away when the book is in use. Dimension “EG”, therefore, should be as small as possible from the usage and handling viewpoint. The requirement for and effect of the value of the edge gap dimension “EG” are thus in conflict.

Looking at FIG. 22B a left ditch 710 and a right ditch 712 are provided in adhesive 704. A narrow left adhesive band 707 thus exists between left gap 706 and left ditch 710. A similar right adhesive band 709 is present between right gap 708 and right ditch 712. The widths of left and right ditches 710 and 712 are sufficient to absorb extrusion from the central body of adhesive 704 and the far smaller left and right adhesive bands 707 and 709.

The effect of having these extrusion ditches allows dimension EG at both gaps 706, 708 to be far narrower than would otherwise be required. The actual dimensions of adhesive bands 707 and 709 as well as the width of the left and right ditches 710 and 712 are dependent upon the thickness of adhesive 704 and the viscosity of the adhesive under melt conditions. Typically, however, dimension “EG” can be reduced by a factor of 50 percent or more by the addition of ditches 710 and 712.

FIG. 22C shows the right edge of this binder-tape structure in close-up detail and introduces a code gap 714. Code gap 714 is not essential to the functioning of the binder or of the binder-tape but is useful for the following reason.

It can be seen in FIG. 22C that at the bottom of code gap 714 is a code stripe 716. The function and structure of this code stripe is described elsewhere in this document and will not be repeated here. The presence of code stripe 716 is essential to the best functioning of the binder and, since it has a finite thickness (usually 0.0015 to 0.0025 inches), it would extend above the surface of adhesive 704 were it not for the presence of code gap 714.

Binder-tape 700 is herein utilized in roll form spirally wrapped upon a cardboard core. The roll binder-tape utilization format is described elsewhere. If code stripe 716 were located atop adhesive 704 it would cause an asymmetrical “bulge” in the roll of binder-tape as it is wrapped on the core. This asymmetry would cause the rolled binder-tape to assume a conical configuration that would then create difficulty in the tracking and feeding of the binder-tape within the binder.

Thus the addition of code gap 714 permits code strip 716 to be deposited “below grade” of the surface of adhesive 704. Thus with this feature added the binder-tape will spool in a perfectly cylindrical manner.

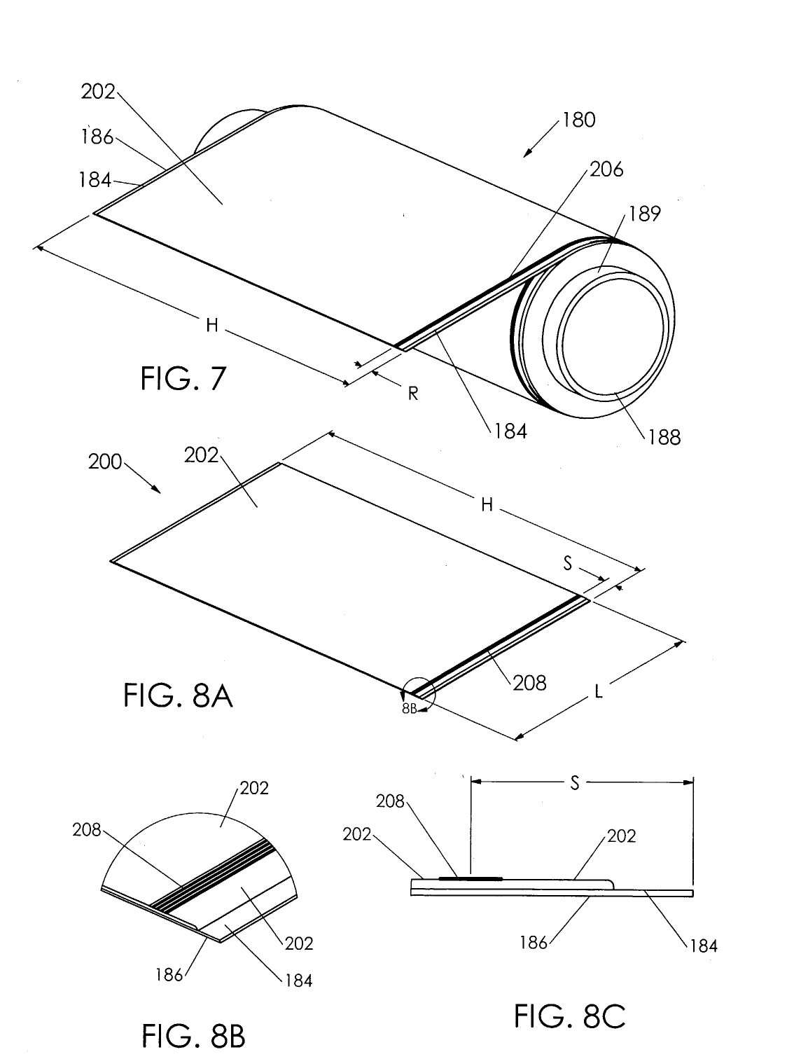

Referring now to FIG. 7 it may be seen that binder-tape may be rolled onto a supporting core 188 to create a roll tape 180 assembly. An edge gap 184 is shown but not required as in the previous discussion. Observe that, for the purposes of this invention an adhesive 202 is on the outside surface of roll tape 180. This configuration is shown because it supports the concepts of the preferred embodiment of this disclosure where the tape feeding mechanism uses binder-tape with the adhesive on the outside. A feeding structure could also be easily designed that utilizes a roll of binder-tape that is wound with the adhesive on the inside of the roll. Outside adhesive construction has certain important advantages but negatively it “hides” the color of the binder-tape. With roll tape 180 loaded into the binder of the preferred embodiment it is desirable for the user to have a means for the user to discern the color of the binder-tape. For this reason a color band 189, which is a strip of the binder-tape, is adhered to an extension of core 188. An optical light pipe or color-pipe 26 can then be used to cheaply and reliably and passively communicate the color of color band 189 to a user looking at a window through the enclosure walls of the binder. This window, color-pipe 26, is shown in FIG. 1A. The detail of construction of color-pipe 26 is very simple and is therefore not shown. Color-pipe 26 is not essential to the operation of the preferred embodiment but it provides a useful function.

Continuing to view FIG. 7, turn your attention toward a code stripe 206 which runs near one long edge of roll tape 180. Code stripe 206 is positioned a distance “R” from the edge of the binder-tape. The reason for code stripe 206 is, as will be shown, that various types of binder-tape other than roll form tape can and will be used in the preferred embodiment. This code stripe 206 is not absolutely required in the operation of this invention but it will be seen that its presence provides a powerful and novel utility. The construction of code stripe 206 is consists of infrared absorbing ink for the purposes of describing the preferred embodiment. Other code stripe designs such as magnetic strip, light reflective or absorbing strips responding to wavelengths other than infrared are easily imagined by a person skilled in the art. It is also possible that the strip be modulated, or encoded by a short form of barcode or other similar scheme. The present code stripe 206 is a simple non-modulated code device that is simply and inexpensively applied in manufacture and read by the binder. The positional dimension “R” specifies the location when the binder-tape media is in roll form. It will be shown that other code stripe edge offsets will be used to encode other useful products that may and will used by the binder of the present invention. Another reason a code stripe is desirable is to inform the machine, and thus the user, that the bulk roll stock is exhausted.

Looking now at FIGS. 8A, 8B and 8C, a sheet binder-tape 200 is being introduced. The sheet binder-tape may or may not be the same fabric/adhesive structure as roll tape 180. A code stripe 208 is located at edge dimension “S” denoting that the binder-tape being introduced into the binder of the preferred invention is of sheet form. This will tell the binder, when read by the binder's sensing mechanism (to be described) that the roll of tape within the binder is not to be fed to the binding station, but rather to utilize sheet binder-tape 200. The reason this is important can be explained by assuming that the stored roll tape 180 is colored “blue”, for example, and that next book (or a few) is to be made utilizing another color of binder-tape. If a short run of books is to be produced it then might be more efficient to temporarily employ sheet binder-tape of a different color rather than load a replacement roll of a different color.

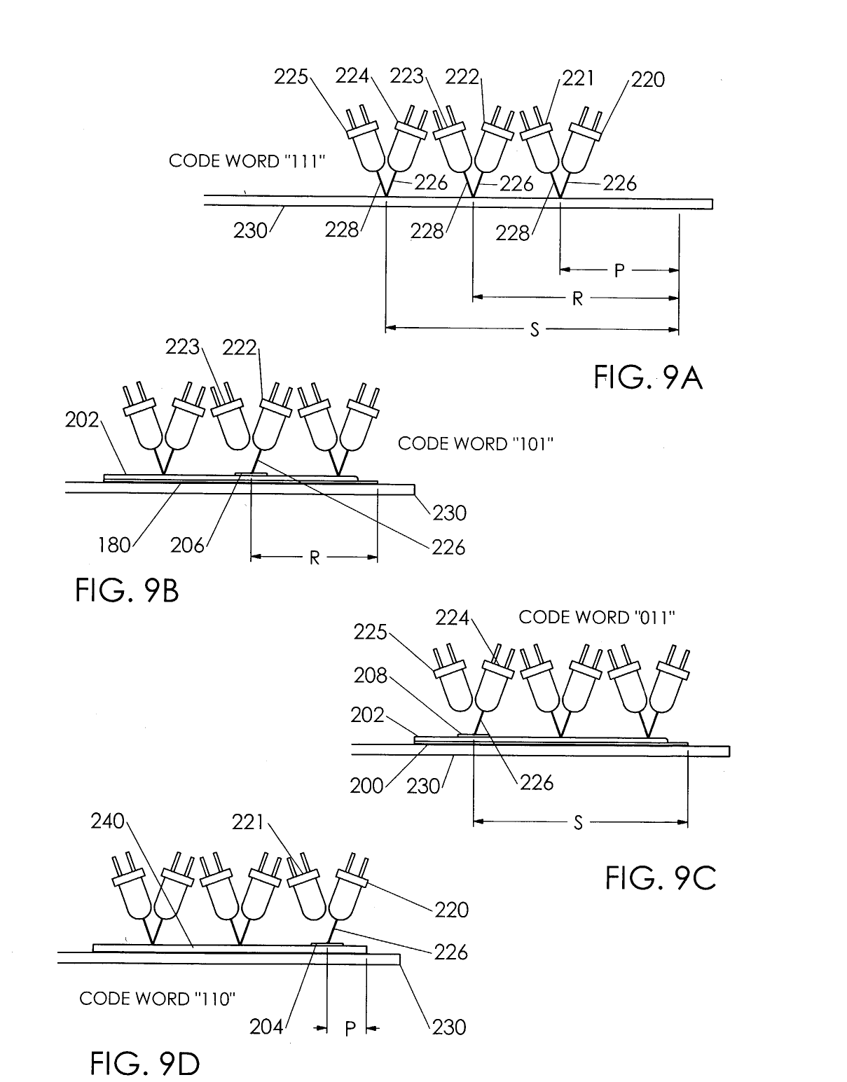

The illustration of FIG. 9A shows a schematic representation of the code stripe sensing mechanism of the preferred embodiment of the present invention. Shown are three sets of I-R (infrared) optical reflective pairs. A light source 220, a light source 222 and a light source 224 are light emitting diodes (LED) radiating at the infrared wavelength and focused at an angle impinging upon a tape support 230. In this illustration there is no binder-tape present in the detection zone of the binder. Tape support 230 is a reflective structure, usually metallic, which is a fixed part of the binder of the present invention. In the case, then, of FIG. 9A the light of all three LEDs reflect at a complimentary angle from the surface of tape support 230 into the lenses of photo detectors 221, 223 and 225. Thus, for this detector state combination, the signal to the binder electronics (all detectors high, code word “111”) indicates no binder-tape in place. Recall that dimensions “R” and “S” denote the code stripe zones of roll binder-tape and sheet binder-tape respectively. For the purposes of this summary, only three code stripes are illustrated. There is no reason that additional or fewer coding zones could not be implemented under the spirit of this invention. Also, as previously mentioned, other detector schemes are viable alternatives to the system of FIGS. 9A through 9D.

In FIG. 9B roll tape 180 is shown to be present beneath the detector array. Adhesive 202 normally has the property of being reflective, to a detectable degree, of I-R illumination. Thus, in FIG. 9B, the two pairs of photo detection optics to the left and to the right of code stripe 206 at location “R” sense a reflection (digital 1). The properties of all of the code stripes including code stripe 206 are absorptive of I-R light. Thus a light emission 226 impinging upon code stripe 206 will not be reflected. A binary digital code word “101” is thus generated telling binder that the roll tape 180 is present and ready for automatic feed into the binding position.

Referring to FIGS. 9C and 9D the same detection mechanism is used to detect the presence of sheet binder-tape 200. By decoding respectively the 3-bit digital words 111, 011, 101 or 110, the binder is thus informed of the readiness (or non-readiness) to perform one of the following tasks: 1—“do not bind”, 2—“bind using sheet binder-tape 200”, 3—“bind using roll tape 180”.

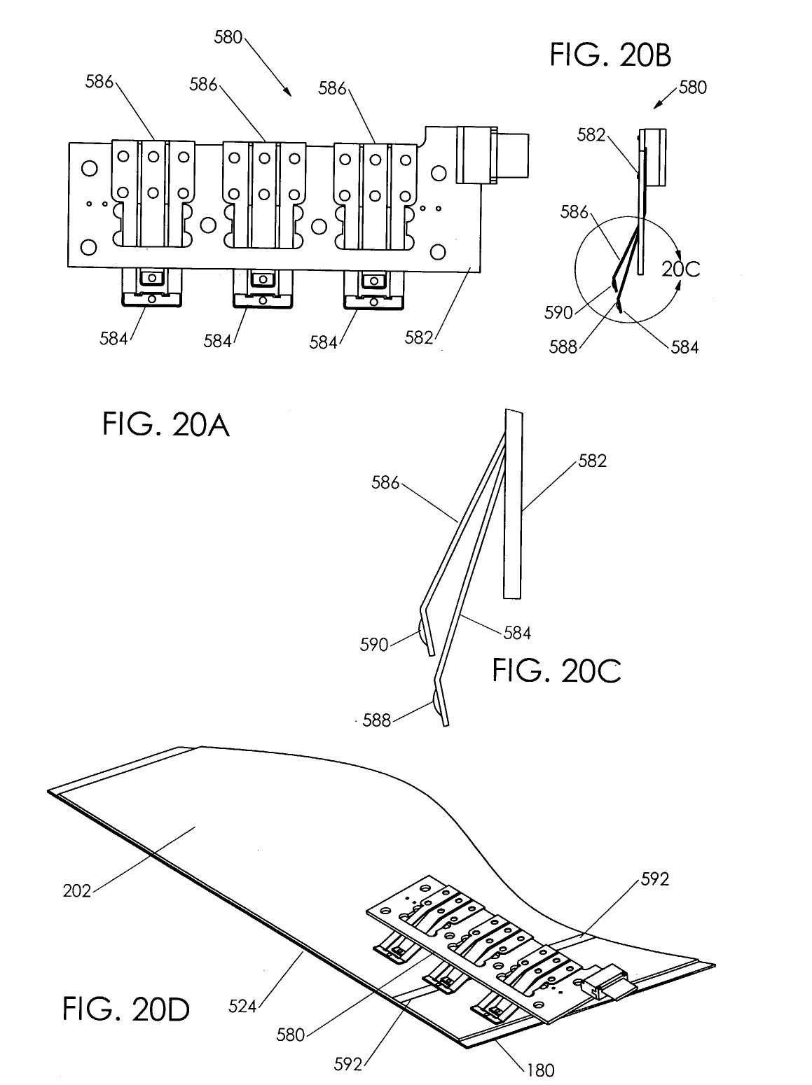

### FIG. 20—Alternate Binder-Tape Encoding Method

FIG. 20A illustrates a device to detect the characteristics of the binder-tape being inserted into the binder. The detection device communicates the characteristics of the binder-tape such as the adhesive composition, bind times, and binding temperatures, and orientation information such as that the binder-tape is properly positioned glue-side up. It can also signal when the roll binder-tape is exhausted and when there is no binder-tape in place to consummate the bind.

The concept of binder-tape encoding is not a new one but this method is unique to tape binding and is especially robust, simple, and inexpensive to apply. It does not rely upon modulated signaling such as bar codes or equivalent known to prior art. The scheme exploits the fact that the binder-tape is in a transverse, or cross-page, orientation instead of being fed along the long free book edge direction. Because of the wide cross-page area available, several side-by-side, non-adhesive, conductive (or, optic or magnetic, etc.) stripes can be printed or otherwise applied to the adhesive side of the binder-tape. These stripes are very thin and very narrow and thus affect, only minimally, the strength of the bind.

Using each of the three code stripe channels shown in FIG. 20 to indicate one of two states (e.g., “on” or “off,” or “0” or “1”), eight coding states may be represented using all three code strip channels: 000, 001, 010, 011, 100, 101, 110, and 111. After using two of the coding states to represent “no tape” and “adhesive side down” conditions, six code combinations remain available to represent other conditions.

FIG. 20A shows the plan view of a detector assembly 580 consisting of a printed circuit board 582 supporting three pairs of linearly arrayed contacts. The contact structure consists of three sets of a long arm 584 and a short arm 586. These contact arms are spring members appropriately fabricated from phosphor bronze, stainless steel, or other suitable material having conductive properties and good leaf spring characteristics. FIG. 20B is a side view of FIG. 20A showing the contact arm elements as well as raised “bumps” on long contact 588 and short contact 590. FIG. 20C is an enlarged detail to better illustrate contacts 588 and 590.

The entire detector assembly 580 is supported within the binder above the binder-tape path just before and close to cutter mechanism 100. The approximate position of detector assembly 580 relative to insertion edge 524 of binder-tape 180 is shown in the perspective view of FIG. 20D. The binder-tape adhesive 202 is installed in its correct “up” orientation for binding. In this illustration a conductive stripe 592 has been applied in code bit position “2”. The code word read by the binder electronics is thus “010” because conductive stripe 592 will bridge the central pair of contacts, whereas the other pairs of contacts remain open since adhesive 202 is nonconductive. If no binder-tape is present, all of the contact pairs will touch the binder surface (not shown) beneath binder-tape 180. Hence, a code of “111” will issue because the binder surface is conductive. Conversely, if the adhesive side is “down,” the non-conductive nature of the tape fabric will code “000.” Thus, if either a “000” or a “111” code issues, the binder will not operate and the binder monitor panel will display an appropriate error message.

Conductive stripes 592 may be produced by several methods and be formed of a wide variety of materials. Metallic and magnetic stripes have been disclosed in the prior art. This invention can utilize metallic stripes. However, the preferred embodiments use non-metallic surface conductors. These include carbon-based inks, paints, and films. The preferred form of the present invention uses a non-metallic polymeric film that is applied in strip form as the binder-tape is produced. As the strip of conductive film may be applied while the adhesive is semi-molten, the film attaches to the finished product with no added labor component. Alternative embodiments use conductive printable polymeric compounds applied directly to adhesive coated webs.

The embodiments above that employ a conductive (or, optically absorbing or reflective) paint, ink, or film, describe surface phenomena. That is, the material is applied on top of the adhesive and will usually, but not exclusively, be non-adhesive. In accordance with the present invention, these embodiments work best when the binder-tape is “cross fed,” that is, fed transversely to the page edges of the book. If such a surface film or paint or ink were applied longitudinally to long, bind edge binder-strip, the non-adhesive stripes would be parallel with the paper pages being bound and the bind would thus probably fail. In the present invention the non-adhesive code stripes can be less than 0.100 inch wide. Assuming 6 code stripes are applied to a standard 8½ by 11 inch page, the aggregate non-adhesive area coincident with the code stripes would reduce the total adhesive area of the page by less than 5.5 percent; having a trivial effect on the strength of the bind.

Current research is being done on adhesive-based conductive polymers. Should the research yield practical results said polymers could be embedded in, or a part of, the adhesive coating of the binder-tape in accordance with the invention.

The cross-bind code stripes of the present invention could also be modulated if desired. They could be read by any means such as optics, direct conductive, magnetic encoding, or electrostatic charge.

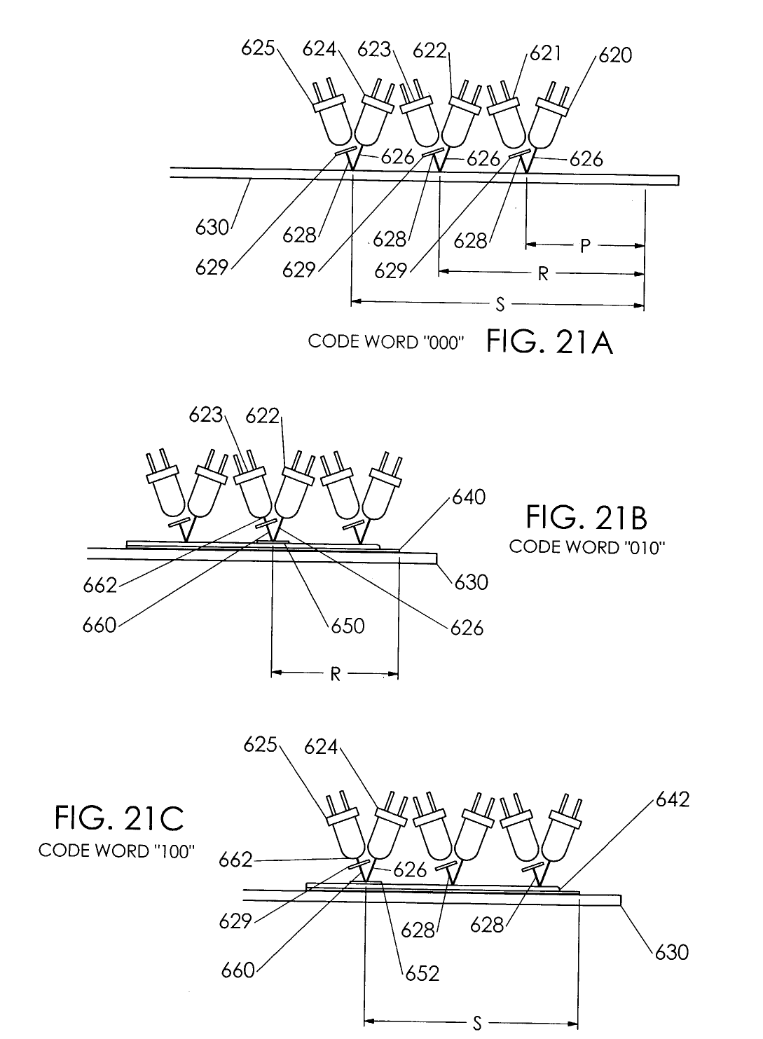

### FIG. 21—Second Alternate Tape Encoding Method

FIG. 21A shows a 3 channel array of photo optical devices designed to detect binder-tape information in a novel manner. The array consists of three ultra-violet (UV) emitting diodes 620, 622 and 624. These diodes emit UV light focused along three UV vectors 626 onto a binder-tape support 630. Alongside each of the aforementioned UV diodes are photo-detectors 621, 623 and 625 which are angled to focus on the areas of binder-tape support 630 illuminated by the UV diodes. An optical filter 629 is placed in front of each of photo detectors 621, 623 and 625. Light will be reflected from the surface of binder-tape support 630 along a vector of reflected UV 628. The reflection pattern is duplicated at each of the UV diodes. The UV filter will block radiation in the ultraviolet band. UV filter 629 may be omitted if detectors 621, 623, 625 are tuned or internally filtered to be insensitive to UV radiation. The presentation herein of three detector arrays is arbitrary and the quantity of detector pairs can be increased or decreased dependent upon the number of parameters to be encoded.

The conditions illustrated in FIG. 21A will return a code word of “000” since detectors 621, 623, 625 are not receiving any photons through the blocking UV filters 629. The “000” code word informs the binder electronics that there is either no binder-tape present or alternatively that binder-tape, if present, is improperly positioned and therefore no binding should take place.

Referring now to FIG. 21B in which is shown a section of roll binder-tape 640 having an imprinted code stripe at dimension “R”. The stripe of this disclosure is a fluorescent stripe 650. This stripe is an ink, a paint, or a similar material which “glows” or emits photons at a different wavelength than that which is striking or “pumping” the material. In the preferred embodiment of this disclosure the “pumping” wavelength has been described as being in the UV optical range. In practice, for reasons of cost, the current best choices are UV diodes radiating in the 400 to 416 nm range.

Reasonably priced fluorescent inks are commercially available which will emit in the yellow or green band when pumped by UV light in the 400 to 416 nm spectrum. These inks may be colorless in the unpumped state or may be pigmented in a visible shade distinct from the fluorescence color. Thus, because of the relatively wide spacing between the various wavelength components of the system it is quite easy to filter out the unwanted UV light bands.

FIG. 21B therefore illustrates how UV vector 626 impinging upon fluorescent stripe 650 will cause the emission of a combined radiation 660 directed at an angle upward toward UV filter 629. The combined radiation 660 is composed of a reflected UV component as well as a distinct wavelength of light produced by fluorescence. UV filter will block the UV component of combined radiation 660 and as a result filtered radiation 662 at the fluorescing wavelength will pass through the filter onto detector 623.

Thus the conditions of FIG. 21B will generate an “010” code indicating that roll binder-tape 640 is present in the binder and is correctly positioned for binding.

Attending now to FIG. 21C, a section of sheet binder-tape 642 is shown imprinted with a fluorescent stripe 652 at location “S”. It may be observed that fluorescent stripe 652 is thus present at the focus of UV diode 624 and a detector 625. As before UV filter 629 intercepts the light path between fluorescent stripe 652 and photo detector 625.

Using the same reasoning as previously described it is clear that a “100” code is generated, telling the binder electronics that sheet binder-tape 642 is correctly positioned and that the bind sequence may proceed.

The operation of the detection pair consisting of UV diode 620 and photo-detector 621 are not described here as the operation is identical to the other detector pairs.

It is clear that this detection array and others, if installed, are capable of encoding a wide variety of binder-tape parameters.

### Spine Title Printing—Overview

The ability to print spine titles is an important advantage of the binder invention. The need for titling is obvious for bookshelf storage of bound documents. “Perfect Bound” documents fulfill this need by the nature of using full wrap pre-printed cover stock. But, as noted previously, the perfect bind solution is generally unsuitable for the short-run, “Print-upon-Demand” binding application. Short run solutions such as wire-bind and ring-bind cannot easily be printed on the spine. This writer is aware of one product serving the “short run” market able to print on a book spine. This product produces an attractive durable spine title and is capable of including logos and other limited custom graphics. It cannot produce half tone images or multiple colors on its spine. The main downside of the product is its cost, currently about $3500 retail, which approaches the price of a binder from the same company.

It will be shown that the present invention requires no additional supportive hardware other than a common computer attached to a commodity inkjet printer. No special fixturing or handling equipment is necessary. The aforementioned available equipment requires custom image composition software for the computer or, alternatively, a custom keyboard computer sold by the same manufacturer. The preferred embodiment of the present invention uses “Microsoft Word®” as a title composer. “Microsoft Word®” is among the most ubiquitous of software and is installed on almost all computers (PC or Macintosh). Similar software having title composition capability is distributed at no cost with most or all “Linux” operating system software.

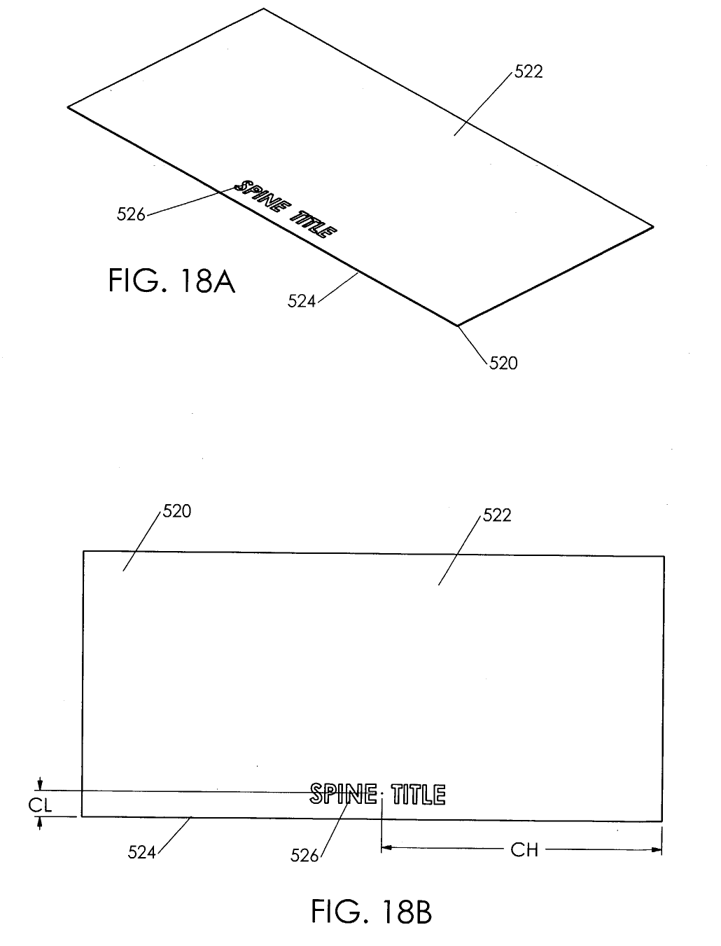

### FIGS. 18A and 18B—Spine Title Print Method

Refer now to FIGS. 18A and 18B. This section describes a method of pre-printing the sheet form binder-tape with spine title text and images. A page of sheet binder-tape 520 is illustrated with the adhesive, not shown, on the back face of the sheet in both figures. A spine title 526 is printed as shown on the fabric side 522 of sheet binder-tape 520. The printing can be the result of any process that will adhere to fabric side 522 and will withstand the elevated temperature of the subsequent binding operations which is estimated to be between 180 and 210C. An inkjet printer satisfies all conditions. Alternative embodiments may use foil, die sublimation, or impact printers.

The fact that the binder of the present invention, unlike prior art tape binders, can utilize binder-tape in a common sheet format permits the use of low cost inkjet printers for spine title preparation. Either 8.5×11 inch or larger format printers may be used to support this invention. Recently developed pigmented inks exhibit improved moisture and fading resistance. The titles thus produced may be attractive and colorful and durable.

Spine title 526 is represented here by a block of text but in reality it is easy to include multiple lines of text with various fonts and colors and orientations as well as emphasizing blocks and stripes of color. Custom logos, clip art and pictures are simple to include. Low cost commercially available applications such as Microsoft Word® and Adobe Illustrator® and many others have built-in capability to easily produce title art limited only by the imagination of the designer.

FIG. 18B shows some key dimensions used in preparation of the title. Dimension CH is usually set by eye for a pleasing effective presentation. Dimension CL, however, is critical and is derived by carefully measuring the book thickness and applying a fixed offset. If the position CL is not accurately set the title will be asymmetric to the thickness of the book, usually an undesirable result.

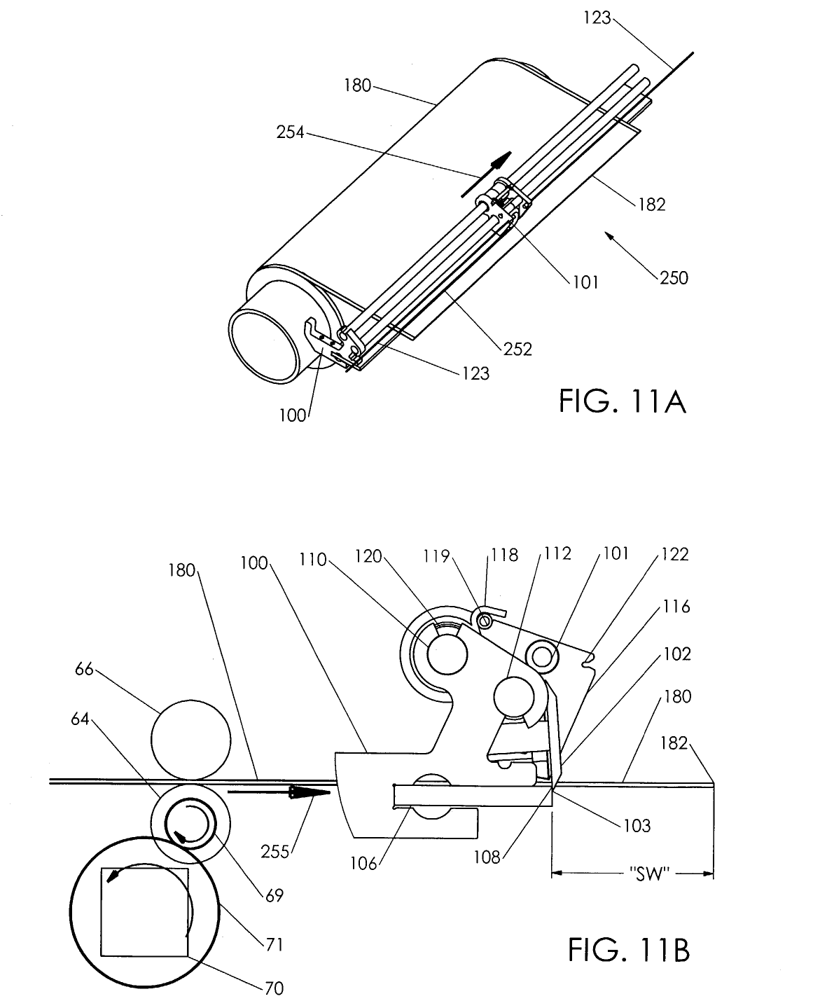

### FIG. 11—Roll Binder-Tape Feed

In FIGS. 11A and 11B a method is shown for the automatic feeding of roll tape 180. This is the preferred method of this aspect of the invention but it is obvious that other forms of feeding a binder-tape are easily envisioned. The preferred embodiment of the feed system consisting of tape roller 64, nip 66, driven gear 69, drive gear 71, and tape motor 70 that were first introduced in FIGS. 1B, 1C and 1D. The illustration of these components in FIG. 11B is schematic for the purposes of description. Roll tape 180 is gripped between tape roller 64 and nip 66. Tape motor 70 is directly coupled to drive gear 71, which in turn drives driven gear 69. Driven gear 69 is attached to tape roller 64. Thus the clockwise rotation of tape motor 70 will drive roll tape 180 in a direction defined by a feed vector 255. FIG. 11B also shows cutter assembly 100, which was described earlier. It is seen in this illustration that roll tape 180 is moved through a slot gap in cutter assembly 100 to a distance “SW” beyond sharp edge 108. The “SW” distance requirement will be described in the operational sequence description.

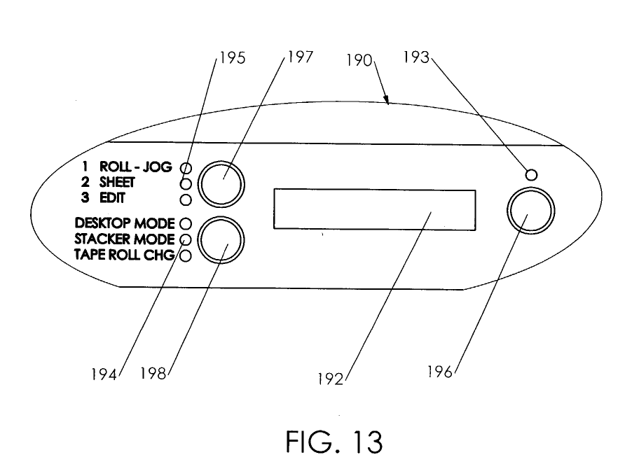

### FIGS. 12-13—Sequences and User Panel

The illustrations in FIGS. 12A through 12R consist of mechanisms that have already been described but which exist to support the operational sequences that follow latter in this disclosure.

A user controls 190 panel area is shown in FIG. 1A and in more detail in FIG. 13. This control panel is representative of a variety of user interfaces which could be designed. User controls 190 shown here is the preferred embodiment of this invention. Referring to FIG. 13 a user display 192 is present to inform the user of pertinent information regarding binder functions. A mode button 198 is used to scroll to the mode in which the binder is to operate. A three set array of LEDs 194 (Light Emitting Diodes) informs the user of the current mode setting. A media button 197 selects the type of bind process to perform while a media LED 195 indicates the currently active bind status. The text alongside the status LEDs is self-explanatory. After the mode and media states are selected, an action button 196 is used to command the next step in the bind process. It will be shown that some activities proceed automatically to completion while other processes pause for user intervention. When a human activity is called for an alert LED 193 may “blink” and user display 192 will describe the required intervention. Alert LED 193 will also flag a “ready” condition; for example, when the binder condition changes from “warming up” to “ready to bind”, alert LED 193 will change from blinking to a steady glow. If there is a fault, a required activity, a “roll-tape empty” or a similar occurrence, the alert LED 193 will blink and user display 192 will present a brief description.

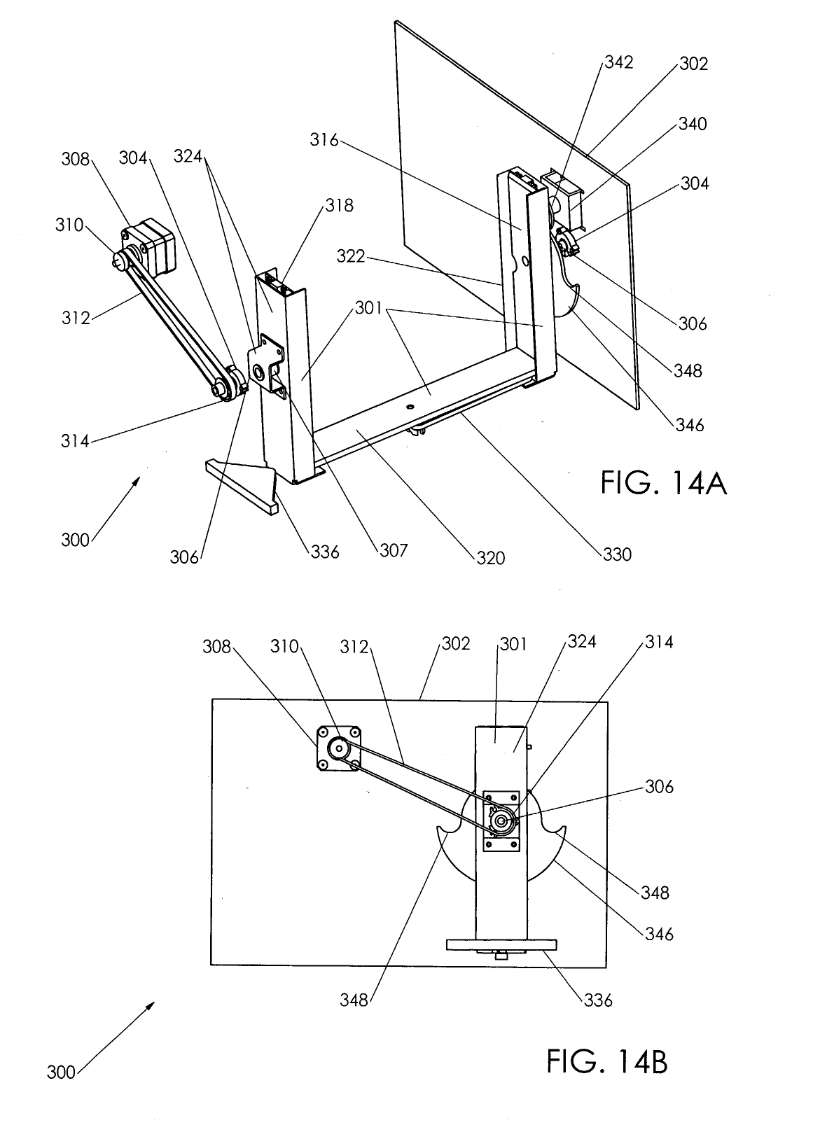

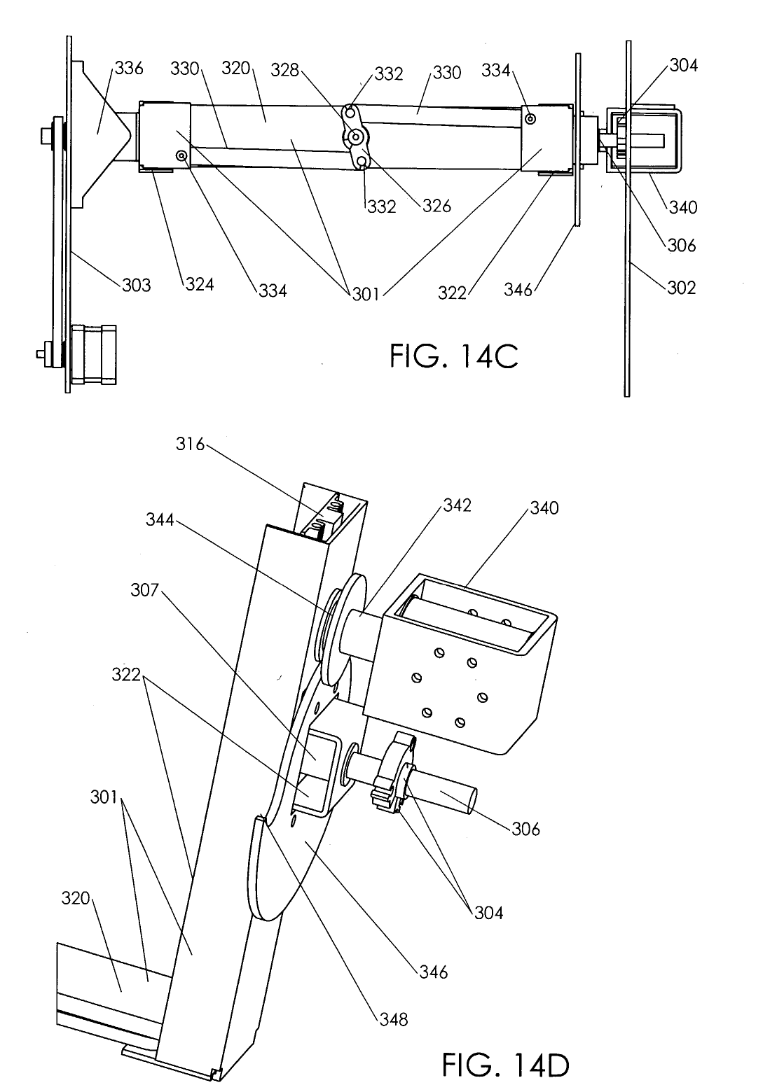

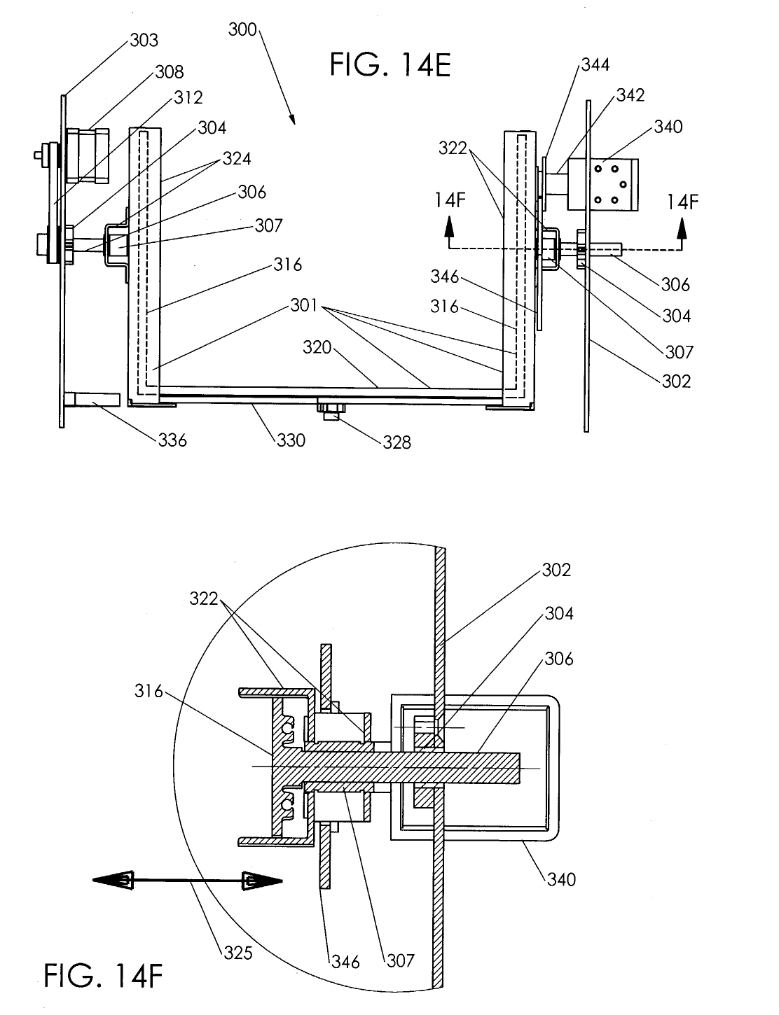

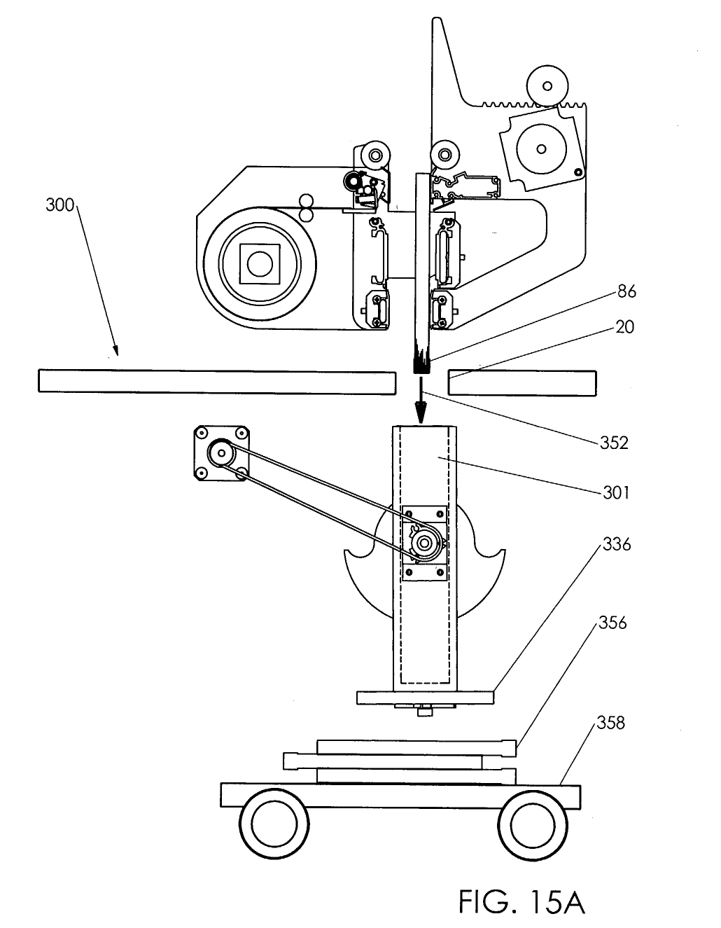

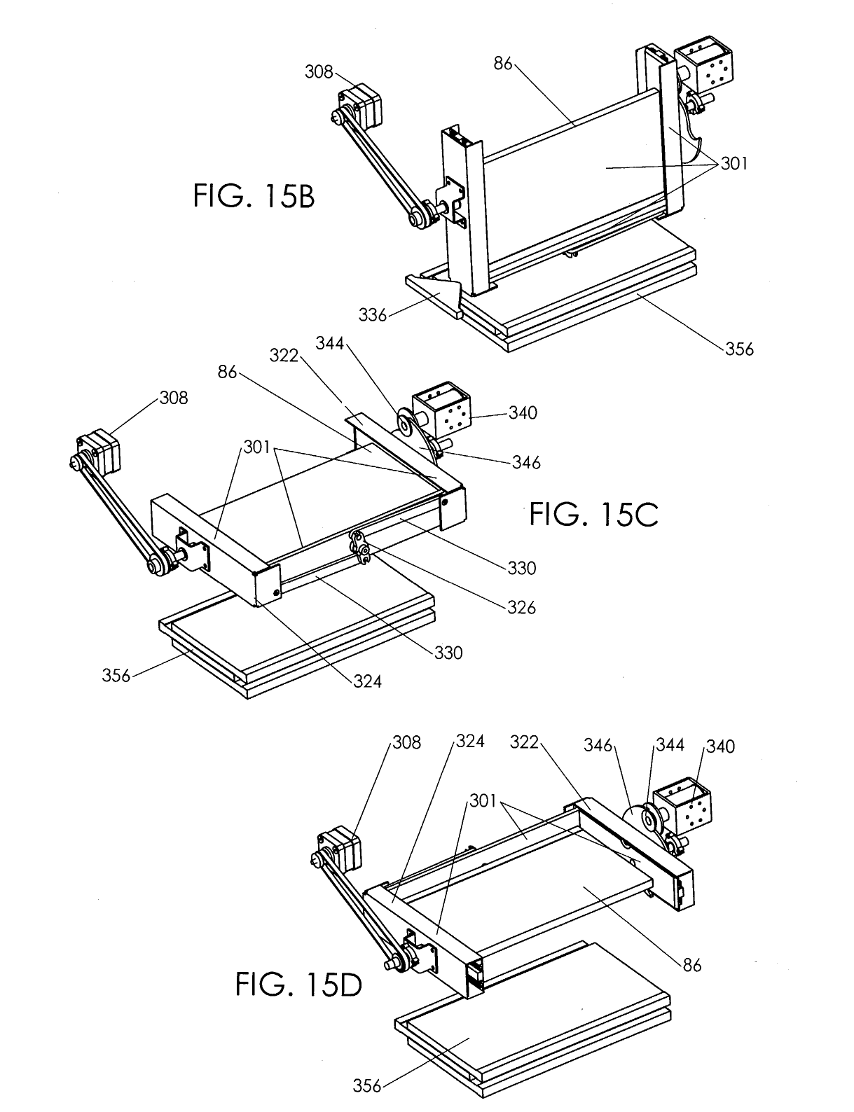

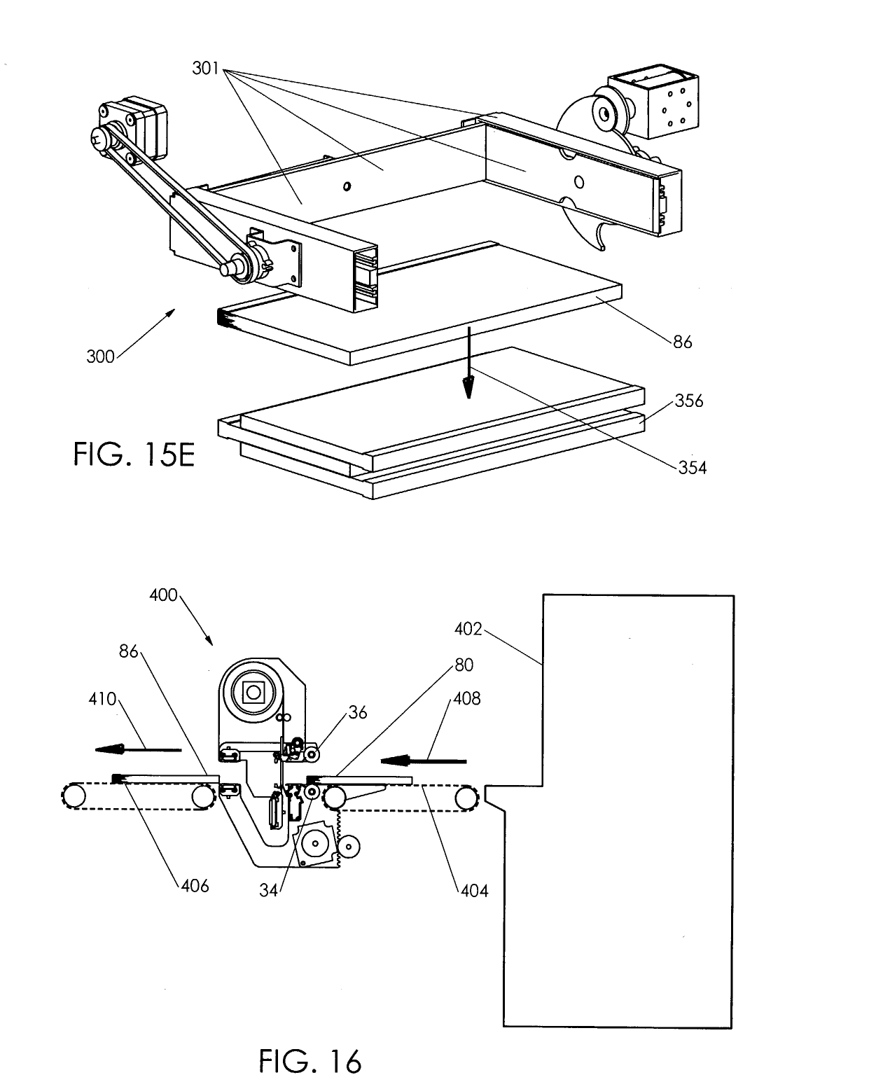

### FIGS. 14A-15E—Additional Embodiments

The description now turns to an optional but very important feature of the preferred embodiment. The current crop of “desktop” tape binders are labor intensive. The binding process typically begins with the manual loading of a “jogged” document bundle into the binder. The tape binding machine activity itself typically consumes 20 to 30 seconds from actuation of the start button to the moment when the finished book is ready for removal. The bound book then must be withdrawn from the binder and transferred manually to a temporary cooling rack. This might typically add 3 to 4 seconds after which the operator must fetch the next book and jog and load the bundle consuming another 8 to 12 seconds. The cooled books in the temporary cooling rack must be transferred periodically to a stack or handling station adding further manual complication to the process. Thus the book-handling portion by itself can easily add 50 to 100 percent to the basic bind time required. The quality of training of binding machine operators is often inadequate and this additional handling complexity can create a distraction of many inter-linked chores at a time when the operator should be concentrating on achieving quality binds. The following describes a mechanism to minimize the handling of a completed book. This mechanism can typically reduce the total binding cycle by 10 to 20 seconds and significantly reduce confusing complexity. This portion of the present invention will be known as the “Stacker/Cooler”.

In FIG. 14A there is presented a Stacker/Cooler 300 consisting of a support plate 302, to which is fastened a pivot bearing 304. There is also a support plate 303 on the other side of the mechanism, which is omitted in this view but is shown in FIGS. 14C and 14E. Alternately viewing FIGS. 14A, 14B, 14C, 14D, 14E and 14F it may be seen that rotationally positioned within each pivot bearing 304 is a pivot shaft 306 which attaches rigidly to a chute side 316 and 318. These parts and their mirror image are rigidly attached to a spine plate 320 cross member. Thus the combination of a chute side 316, a chute side 318, pair of pivot shafts 306 and spine plate 320 comprise a “yoke” structure that is free to rotate within the pair of pivot bearings 304. This “yoke” structure is best understood by referring primarily to FIG. 14E. A yoke/chute 301 sub-assembly is created by the addition of a right side capture channel 322 and a left side capture channel 324 to the just described “yoke structure”. The capture channel 322 with an attached channel bearing 307 is constrained in a linear fashion on the right hand instance of pivot shaft 306 as seen in FIG. 14F. There is a mirror image of this combination on the other side of the device consisting of a capture channel 324 and another channel bearing 307 guided on the second instance of pivot shaft 306. In FIG. 14F it may be observed that capture channel 322 along with it's attached channel bearing 307 can only slide along pivot shaft 306 because the “U” shaped configuration of capture channel 322 wraps loosely about chute side 316. The cross-hatching clearly delineates the sliding elements. Thus this channel structure can only slide, not rotate, with respect to chute side 316. This linear motion constraint also applies to the far side capture channel 324. Referring to FIGS. 14C and 14E it is seen that a cam 336 is attached fixedly to support plate 303. The purpose of cam 336 is to force capture channel 324 to the right, or inward, when the yoke structure is in the vertical positions of FIGS. 14A through 14F. When yoke/chute 301 is rotated away from vertical, cam 336 has no effect upon the ability of capture channels 322 and 324 to slide to their mechanical limits.

To complete the understanding of the sliding behavior of capture channels 322 and 324, turn your attention to FIG. 14C which shows an underside view of the mechanism of FIG. 14A. A bellcrank 326 is pivoted about a bellcrank bearing 328 attached to spine plate 320. A pair of bellcrank links 330 is attached to, and extends to, the right and left of, bellcrank 326. The bellcrank attachment points of the three parts are a pair of link pivots 332. The far right and left ends of both of bellcrank links 330 attach by a pair of channel pivots 334 to capture channel 322 on the right and to capture channel 324 on the left. Thus it can be seen that sliding capture channel 322 away from the center (outward) of the mechanism in FIG. 14C will cause a corresponding synchronous movement of capture channel 324 in the opposite direction. However, if yoke/chute 301 is vertically disposed as in the illustrations of FIGS. 14A through 14F, cam 336 will force both capture channels 322 and 324 inward. The purpose, therefore, of cam 336 is to return (close) capture channel 324 and capture channel 322 toward the center of yoke/chute 301 when yoke/chute 301 is vertically disposed.

Returning again to FIG. 14A direct your attention to a pivot motor 308 and its attached drive pulley 310. This driving pair is rotationally coupled to a driven pulley 314 by means of a drive belt 312. Driven pulley 314 is affixed to the instance of pivot shaft 306 on the left side of the mechanism. Therefore rotation of pivot motor 308 in a clockwise direction will cause yoke/chute 301 structure also to rotate clockwise and vice versa. Cam 336 is shown to push inward upon capture channel 324 when yoke/chute 301 assembly is in vertical position shown. When capture channel 324 is in any other position than near vertical cam 336 has no effect.

A solenoid 340 with constituent parts consisting of a solenoid plunger 342, and a plunger cap 344 are shown most clearly in FIGS. 14D and 14E engaged with a connector disk 346 by means of a groove in plunger cap 344. A pair of disk notches 348 is a feature set of connector disk 346. These notches serve to increase the contact area of connector disk 346 with the groove of plunger cap 344 when the mechanism has been rotated to one extreme or other. This rotational concept will be explained in detail further along in the discussion. Many of these same parts are also illustrated in FIG. 14C should clarification be necessary. When solenoid 340 is energized solenoid plunger 342 and its plunger cap 344 pull powerfully and quickly to the right. By the groove engagement of plunger cap 344 attached to capture channel 322 it can be seen that the bellcrank synchronized capture channel 322 and capture channel 324 will quickly slide outward relative to the center of yoke/chute 301.

The illustration of FIG. 14D shows the relative position of capture channel 322 to connector disk 346. The reduced diameter of connector disk 346 is loosely engaged within a groove machined in plunger cap 344. Thus as yoke/chute 301 is rotated, one or the other of disk notches 348 will revolve toward plunger cap 344. The groove in plunger cap 344 will ultimately engage one of disk notches 348. One or the other of disk notch 348 pair of connector disk 346 will be concentric with the groove of plunger cap 344 at the instant of operation of solenoid 340. The purpose of disk notches 348 is to provide additional load carrying capacity when solenoid 340 is energized. The mechanism will be seen to be functionally active at one of three rotational states: 1—the approximately vertical yoke/chute 301 of FIG. 14A or, 2—a horizontal yoke/chute 301 clockwise of vertical or, 3—a horizontal yoke/chute 301 anti-clockwise of vertical.

The mechanisms of FIGS. 14A through 14F are representative of the current preferred embodiment. Other mechanisms could achieve the desired motions and functions described. The spirit of the invention is unbroken through the substitution of such mechanisms.

Turning to FIG. 15A it is seen that the binder mechanism of FIG. 12P is integrated with Stacker/Cooler 300 by positioning the bottom book exit, opening 20, of the binder directly above the channel shaped yoke/chute 301 entrance shown in FIG. 14B. A transfer vector 352 describes the vertical motion of bound book 86 as it transfers from the Binder to Stacker/Cooler 300. Shown below Stacker/Cooler 300 is a book stack 356 representing a three book staggered stack of cooling bound books 86. Obviously, the distance of the binder above the floor limits the capacity of the book stack. Supporting book stack 356 is a book cart 358 for receiving the book stack and for book transport purposes. The combination of book stack 356 and book cart 358 is representative of an economic and efficient preferred embodiment of this invention. A conveyor system or other robotic mechanism could easily be substituted for book cart 358 shown.

The illustrations of FIGS. 15B, 15C, 15D and 15E illustrate the operational sequence of Stacker/Cooler 300. These illustrations show bound book 86 at various stages of its passage through the system. All the components shown in these illustrations have been previously described.

### FIGS. 16—Automation Embodiments

The illustration of FIG. 16 introduces a schematic form of the preferred method of integrating the binder and a copier or printer. Shown are horizontal conveyors for book handling. Thus in more detail a printer/copier 402 is shown to the right of a horizontal binder 400. Horizontal binder 400 is the mechanism of FIG. 12A with the exception that it is oriented (rotated CCW) by approximately ninety degrees. An in-feed conveyor 404 of the moving belt type connects the document exit of a printer/copier 402 with the entrance slot of horizontal binder 400. An out-feed conveyor 406 is schematically shown at the book output port of horizontal binder 400. The principal reason for this configuration is that many printers and copiers feature a horizontal document exit directly adaptable to a conveyor/automation system similar to that shown. Importantly it should be noted that the binder of the current invention is able to function in nearly any orientation, unlike “Perfect Binder” machines whose orientation is dictated by the requirement of a pot of molten glue. Prior art binders also suffer from the inability to orient other than with the book entry (and exit) facing upward. This illustration demonstrates the overall versatility of the present invention and shows the commercial value of the straight-through binding path. Many other automation schemes are possible including vertical paths as well as combination horizontal/vertical pathways. The previously described Stacker/Cooler 300 is also easily integrated as a transport stacker and handler into the automation concepts of FIG. 16.

### Operation of the Invention

### FIGS. 11A-11B—Utilizing the Binder-Tape Roll Supply

Before proceeding into the sequential description of the operation of the binder of the present invention it is desirable to understand the operation of the cutting, or severing, of the binder-tape into usable widths. The illustrations of FIGS. 11A and 11B combine the devices and media described in FIG. 5B and FIG. 6A and FIG. 7. A cutter/tape combination 250 is shown in FIG. 11A. The roll form of binder-tape is used for purposes of illustration. The description is equally applicable to the severing of sheet binder-tape 200 of FIG. 8A.

Turning again to FIGS. 11A and 11B, the operation of the binder requires the roll style of binder-tape 180 be automatically (or manually in the case of the sheet form of binder-tape) fed into the machine a predetermined distance “SW”. Dimension “SW” is a variable dependent upon the number of pages, or the thickness, of the book being bound. The amount of binder-tape fed, “SW”, is the sum of the thickness of the unbound book 80 and an overlap sufficient to wrap up onto both the front and the rear book cover faces. The cutter head 101 of the cutter mechanism normally occupies a passive position at one extreme or other of its travel. This starting position is not shown but is easily understood. The position of cutter head 101 shown in FIG. 11A is approximately halfway through the process of creating a severed length of binder-tape. With cutter head 101 at an extreme position, the binder-tape has a free pathway to be fed into the binder a distance “SW”. The cutting action indicated by cutter motion 254 does not occur immediately but at a time partway into the binding process. The timing of the severing of the binder-tape or of the print transfer sheet will be described later in this operational description.

### FIGS. 12A-12N

### Binding in Desktop Mode

The temporal sequence of binding of the preferred embodiment can be assumed to begin with the machine in the condition represented in FIG. 12A. In this illustration moving support 45 is in the open condition with a large gap separating drive roller 34 and slave roller 36. Unbound book 80 is shown after having been placed with the paper edges of unbound book 80 resting upon the top surface of cold platen 44. This is the “Ready to Bind” condition using roll binder-tape 180.

Sometimes when the document bundle is inserted into the binder as shown in FIG. 12A, the pages of the bundle are not all aligned firmly against cold platen 44. If this misalignment obtains, the resultant bind will often be defective because the adhesive will not reach the edges of those pages. If this is the case this invention is capable of “jogging” the pages into alignment by rapidly oscillating cold platen 44 upward and downward through a short arc. This has the effect of breaking the frictional contact between pages and allowing gravity to settle all pages against cold platen 44. This sequence can either be automatic as in the case of the preferred embodiment or manually initiated.

An operator button push (or an automatic signal) next commands moving support 45 to close to the point where unbound book 80 is clamped between drive roller 34 and slave roller 36 as shown in FIGS. 12B and 12C. The enlarged detail of FIG. 12C shows the clearance gaps “CF” and “CM” mechanically built into the system. These clearances allow the pages near the bind interface to not be compressed tightly. This lack of compression provides for a small air gap between the individual pages which will allow binder-tape adhesive to wick a short distance into the book providing the strongest of binds.

In FIG. 12D the unbound book 80 is lifted by the rotation of drive roller 34 and driven roller 36 from the surface of cold platen 44 a short distance described by a bundle motion 256. This action is initiated by the rotation of book motor 72 driving drive roller 34 via drive belt 74.

Referring to FIG. 12E it can be seen that the next operation is the feeding of roll tape 180 through cutter assembly 100 in the direction of feed vector 255 to a position shown at uncut edge 182. This position is detected by the (not shown) action of an optic or mechanical detection means attached to moving support 45. The amount fed into the binder is the distance “SW” of FIG. 11B. Uncut edge 182 is guided at an upward angle by the array of tape lift fingers 76. The reason for lifting of the binder-tape will be explained below.

Turning to FIG. 12F it is seen that hot platen 48 has exchanged places with cold platen 44 in the “active” position below unbound book 80. The mechanism of this exchange of position is illustrated in FIG. 4D. At this point it is important to note that only the portion of roll tape 180 directly under the spine of unbound book 80 is touching the hot surface of hot platen 48. The array of tape lift fingers 76, have curled the right hand edge upward so that the adhesive at that end of roll tape 180 is not heated to a high temperature. At the other (left) side of the tape beyond unbound book 80 the heated surface of hot platen 48 terminates. Thus very little heating and adhesive melting occurs other than directly beneath the spine area of unbound book 80.

In FIG. 12G the next operation sequence consists of the feeding of unbound book 80 indicated by bundle motion 256 such that the spine surface of unbound book 80 rests atop the adhesive of roll tape 180. The downward force of bundle motion 256 firmly squeezes roll binder-tape 180 between unbound book 80 and the hot surface of hot platen 48. This positive “squeezing” action ensures efficient and rapid heat flow through roll tape 180 thereby melting the adhesive. The adhesive viscosity then rapidly lowers by heating such that it readily wicks between the individual pages of unbound book 80. This heating and melting activity normally takes between seven and ten seconds depending upon the adhesive characteristics. Adhesive properties and thus the “time to bind” are not germane to this disclosure. Suffice it to say there are myriad adhesives commercially available wherein the selection of which and the tuning of binder sequences and temperatures are critical to the production of rapid, superior binds.

FIG. 12H depicts an instant in the interval of adhesive heating of FIG. 12G. At this time roll tape 180 is firmly clamped by the pressure of unbound book 80 upon hot platen 48. At this moment the severing of the binder-tape (roll-form or sheet-form) occurs. The cutter head 101 of cutter assembly 100 is drawn transversely across the binder-tape cleanly severing an appropriate section of binder-tape 185. This cutting action is best illustrated in FIGS. 11A and 11B. After the cut is completed the new uncut edge 182 of roll tape 180 is withdrawn a distance along feed vector 255 by the mechanism first shown in FIG. 11B. At the instant depicted in FIG. 12H, the adhesive is wicking into the pages and beginning to form them into a partially bound book 82. The binder-tape side flaps are still unheated and protrude laterally from the spine.

Turning to FIG. 12J, the next operational sequence takes place after a time sufficient to satisfy all the viscosity conditions dictated by the adhesive being used. At this time the platen driving mechanism is activated, rotating cold platen 44 into the active position beneath the book spine. The binding process dwells at this juncture for a time, generally between 4 and 8 seconds, adequate to cool and cure the adhesive to a rubbery state.

Next cold platen 44 and hot platen 48 are pivoted along motion vectors 257 into a “halfway” position approximating that seen in FIG. 12J. This creates an opening directly beneath partially bound book 82.

The partially bound book 82 is driven downward in the direction indicated by the bundle motion vector 256 to a point indicated in FIG. 12K. Note that the “flaps” of binder-tape 187 are beginning to be formed up by their contact with the funnel shaped top edges of side-seal platen 56 and second side-seal platen 62. By now the adhesive at the spine has cured sufficiently to adhere to the spine, but is soft enough to fold, or crease, when the tape is formed up as book 84 is driven further into the space between side-seal platens 56 and 62.

The side-seal strip edges 178 are shown completely folded against the front and rear cover of partially bound book 84 in FIG. 12L. The heated side-seal platens 56 and 62 cause the adhesive of the binder-tape to melt and attach the binder-tape to the front and rear cover sheets. The temperature of the adhesive is not allowed to get as high as was the case in the spine binding operation. There is no need for wicking so the viscosity is kept higher. A common problem in tape binding is that hot liquefied adhesive can be squeezed from the interface between the binder-tape and the front and rear of the book creating an unsightly appearance. This problem has been addressed with a dual adhesive system in U.S. Pat. No. 4,496,617. This method works well but has the disadvantage of requiring a more expensive second application of a different high viscosity adhesive along two edges of the longitudinal form of binder-strip. In the present invention the problem is controlled without resorting to expensive, extra high viscosity edge glue. Instead, as can be seen in FIG. 12L, partially bound book 84 is driven only part way into the opposing heating jaws of side-seal platens 56 and 62. Thus at the top of the heating jaws, short distance air gaps 176 are created. At this point the hot platen surfaces gradually taper away from the faces of partially bound book 84 creating a gradually diminishing heating of the adhesive. The adhesive opposing air gaps 176, is therefore characterized by an increasing viscosity barrier at strip edges 178. This high viscosity band performs the same anti-extrusion function as the dual adhesive system. The viscosity is easily controlled by the depth that partially bound book 84 is driven into the jaws as well as the side-seal platen temperature and dwell period.

After a suitable dwell period within the hot side-seal platens 56 and 62, the book bind is complete. At this point, one of two actions can prevail. In the first instance, if the binder is in the “desktop mode” as shown in FIGS. 12M and 12N, bound book 86 is returned to the top entry/exit opening where the binding process began. FIG. 12M illustrates how bound book 86 has been lifted by the jaw roller along bundle motion 256 vector, and platen vector 257 has rotated cold platen 44 to a position underneath bound book 86. In FIG. 12N moving support 45 has opened and bound book 86 is now free to be removed from the binder. Note again that the binder mode is user selectable by the buttons of user controls 190 as shown in FIG. 13.

### FIG. 12P—Binding in “Pass-Through” Mode

The second, alternate, operational book path will herein be known as the “pass-through mode”. The pass-through mode is an extremely important and novel aspect of this invention. Pass-through enables a very simple, robust method of integrating this binder with automated book finishing systems. Pass-through is illustrated in FIG. 12P which shows moving support 45 in an opened position thereby allowing bound book 86 to slide downward by gravity. For the purposes of the preferred embodiment user controls 190 of FIG. 13 refers to the pass-through mode as the “stacker mode”. It will be shown later that this downward book release can couple directly to a book “stacking and cooling” mechanism that has previously described and which is a part of this invention. It will also be shown to be an advantage of this invention that the binding mechanism illustrated throughout this disclosure may be rotated 90 degrees (or any angle) without compromising any of the described features. A right angle rotation will be shown to permit a very simple integration with a horizontal input and output book conveyor system. All of this can be accomplished with only very minor alteration of the described binding invention. This aspect of the invention directly enhances its utility in the “Print-on-Demand” market and is thought to be unique among binders of its class.

### FIG. 12R—Sheet Binder-Tape Usage

Referring to FIG. 12R it is seen that sheet binder-tape 200 can be substituted for roll tape 180 to bind a book at any given instance. To enable this function the user must switch the machine to the “Sheet Tape” status by a scroll of media button 197 shown in FIG. 13. In this case, at the point in time that unbound book 80 is lifted from cold platen 44, the mechanism is paused. The user display 192 next requests the insertion of sheet binder-tape 200 into a feed chute 260 opening in the top of the binder. The feed chute 260 is shown in the preferred embodiment of FIG. 1A and in side section view in FIG. 12R. The detection mechanism of FIG. 9C will sense that a sheet form of binder-tape is properly inserted and the next depression of action button 196 will resume the bind process as described before but using sheet binder-tape instead of roll binder-tape. It should be noted that this process could be automated with a sheet feeder or a second roll tape storage could automatically supply a binder-tape of a different color.

### FIGS. 15A-15E—Stacker Book Handling

The illustration of FIG. 14A shows a standalone perspective view of Stacker/Cooler 300. Turning ahead to FIG. 15A it is seen how Stacker/Cooler 300 is integrated with the binder mechanism of FIGS. 12A through 12P. The capture channels 322 and 324, best seen in FIG. 14A, together with spine plate 320 form a closed, vertically oriented “chute” which is positioned directly under the “pass-through” exit opening 20 for reception therein of a bound book. The capture channels 322 and 324 are held closed by the action of cam 33. In FIG. 15A bound book 86 is seen to be dropping directly along a transfer vector 352 into the chute. The bound book 86 will come to rest when the book spine strikes spine plate 320. The bound book 86 is now captured, or nested loosely, between capture channels 322, 324, as illustrated in FIG. 15B.

FIG. 15A also shows a wheeled book cart 358 that supports a book stack 356. The book stack 356 will be shown to be the result of the stacking operations of the Stacker/Cooler 300. The book cart 358 allows for rapid removal and transport of book stack 356 to packaging and shipping stations. This book cart 358 could as easily be replaced by a moving horizontal conveyor or by a robotic system.

The binder is not shown in the next figures and operations descriptions since the two mechanisms function independently until the next bound book 86 is transferred to Stacker/Cooler 300. During the period following Stacker/Cooler 300 operations the binder is free to independently perform binding operations the operations of the Binder and of the Stacker/Cooler are thus seen to function in parallel thereby shortening the overall binding cycle.

In FIG. 15C, capture channels 322, 324, and spine plate 320 of Stacker/Cooler 300 are shown rotated clockwise to a horizontal position. This locates bound book 86 horizontally directly above a previously created book stack 356 residing below the horizontal channels and spine plate. Notice that the book spine ends of book stack 356 are staggered alternately left then right for the purpose of level stacking and improved cooling of the warm spine area. Books bound with hot melt adhesives must be allowed to cool for a period in an un-stressed state to allow the adhesive bind to develop handling strength.

FIG. 15D is perspective view of the illustration of FIG. 15B showing capture channels 322, 324 and spine plate 320 rotated anti-clockwise with bound book 86 retained by capture channels 322 and 324. The bound book 86 will be held in this position as long as possible consistent with the need to synchronize with the feed of the next book. This holding period is to provide maximum gain in bind strength before releasing the book to the cooling stack.

When the time to release bound book 86 occurs, solenoid 340 shown in FIG. 15D will be energized to rapidly withdraw capture channels 322 and 324 from support of bound book 86. The solenoid plunger 342 (see FIG. 14D) and plunger cap 344 actuated by the energizing solenoid 340 pulls connector disk 346 and simultaneously opens capture channels 322 and 324. This full opening of capture channels 322 and 324 is complete within 25 milliseconds. The illustration of 1 SD shows that capture channels 322 and 324 are opened but at the instant in time where bound book 86 has not yet begun to descend. Upon the very rapid opening of the channels bound book 86, will drop directly to the stack as shown midway in its fall in FIG. 15E. The aerodynamics of this release of what may be characterized as a flat plate is such that bound book 86 will drop long distances, along a drop vector 356 without pitch, yaw or roll. The shock effect upon a partially cooled bind is not a problem since the contact with the stack is quite uniform and at right angles to the direction of bind weakness.

When the next bound book 86 is deposited in the chute, as in FIG. 15B, the attendant rotation of channels 322, 324 and spine plate 320 is the opposite direction from the proceeding one. This places the spine at the opposite side of the stack. Since the axis of rotation of the yoke is asymmetric to the center axis of the book between spine and unbound page edges the stack will grow with alternately staggered spines as in FIG. 15E. This staggering keeps the hot end of the books completely in free air thereby greatly facilitating cooling. Forced-air cooling can easily be added to the system to further enhance strength buildup.

It should be noted that the stack of books shown in FIG. 15A is formed directly on a wheeled platform so when the stack volume, or height, becomes full book cart 358 can be quickly wheeled away and replaced with a second cart with no loss of productivity. It is also the intention of this invention that in some instances a conveyor may replace the cart and therefore stacks of individual books can be automatically sequenced to packaging and shipping operations.

### FIG. 16—Automatic Printer/Binder Operation

FIG. 16 shows the Binder as an element integrated into a fully automatic system comprising a printer/copier 402 and horizontal binder 400. This functional integration is, in an application sense, a step beyond the simple “Desktop Mode” operation of the Binder as described earlier in this disclosure. The desktop installation of FIG. 1A is most suited to short runs (1-20 books in sequence) of book production. The disclosure of FIG. 16 illustrates the extension of usefulness of virtually the same binder mechanism of FIG. 1A into a highly automated system capable of efficient production of book runs of from 1 to 100 or more. Unlike the utilization of a “Perfect Binder” in a similar automation system the present invention costs about half as much and does not require being “on” continuously, consuming power. Because of the present invention's ability to operate in any position and its novel characteristic of pass-through book feed, complex book handlers are not needed to enable adaptation to almost any variety of printer or copier.

An unbound book 80 of FIG. 16 is shown on a infeed conveyor 404 entering the open jaws of the previously described horizontal binder 400, infeed conveyor 404 having received unbound book 80 from a collated, page justified, horizontal output tray of printer/copier 402. The rotational speed of the drive roller 34 is synchronized to the speed of the infeed conveyor 404 thus assuring the orderly passage from conveyor to binder. The binding sequence is not illustrated since that series of operations are identical to the process described earlier except that the orientation of book flow is horizontal instead of being substantially vertical. The exit of the bound book 86 of FIG. 12P is by gravity release. In the FIG. 16 gravity is not available to move the book. Instead, the out-feed conveyor 406 takes over the process of removing the bound book 86 from the binder and transporting it along an out-feed vector 410 to the next, here undefined, workstation.

The current crop of reasonably priced on-line printers are capable of from 20 to 85 pages per minute which, assuming a minimum reasonable book size of 25 pages, will create a maximum of one to three books per minute. The binder of the present invention can prepare a fully bound book within twenty to thirty seconds. This bind rate, therefore, integrates well with an under $500-$5000 printer without impeding the process. Most books would average more than 25 pages. If the book were less than, perhaps, 20 pages then the binder might become the gating device. However, other features, such as higher-powered heaters, forced air-cooling, faster drive motors, and can be added to improve binder throughput. The binder of the present preferred embodiment is, therefore, eminently matched to other members of its technology niche.

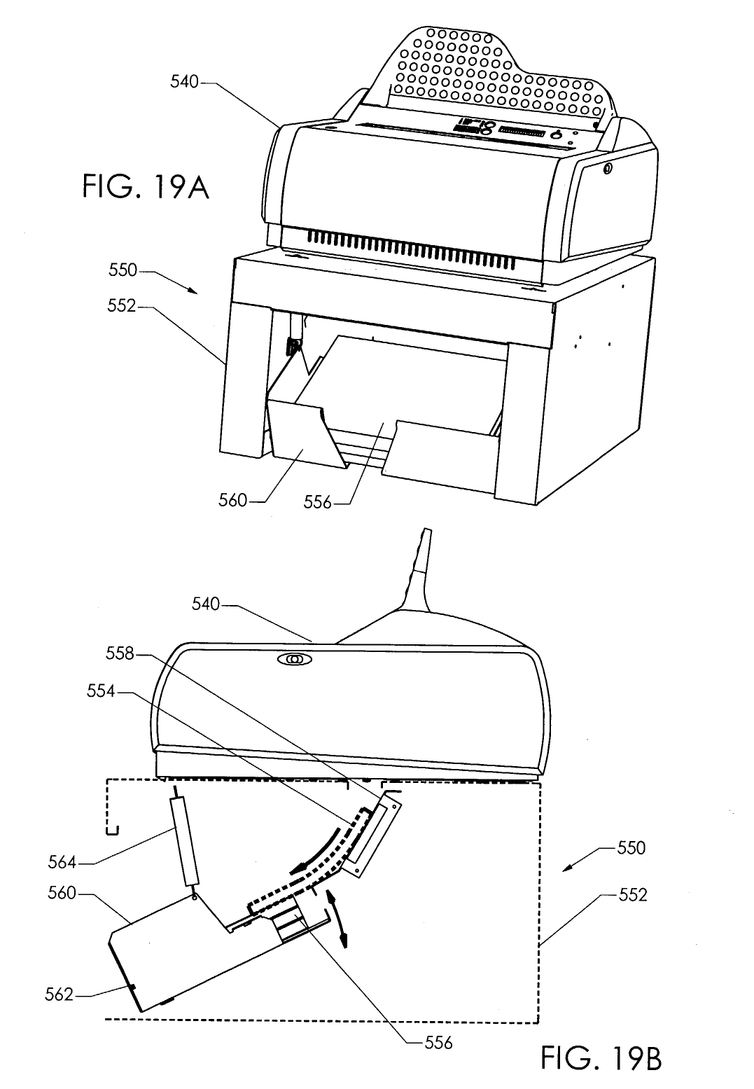

### FIGS. 19A AND 19B—Alternate Stacker Mechanism

Turning now to FIGS. 19A and 19B, a second embodiment of a post-binding book handling mechanism is illustrated. While the previously described mechanisms of FIG. 15 are engineered to service the high volume binding installation, it will likely prove too costly a mechanism for the small office. This portion of the invention is conceived to economically exploit the straight through book path of the binder of the present embodiment. The stacker mechanism here described should retail economically and is sized to fit on the desktop occupying no more desk space than the footprint of the binder itself. The previously described desktop binder 540 is shown atop a ballistic stacker 550 of the present embodiment. The stacker consists of an enclosure 552 containing a spring supported hinged basket 560 positioned to receive the books automatically as they are bound. In FIG. 19A a book stack 556 is shown containing three books by way of illustration. In FIG. 19B the same elements are shown with the exception that enclosure 552 is cut away represented by a dashed outline. Also shown are an extension spring 564, a curved chute 558, and a basket pivot 562 about which hinged basket 560 can rotate.

The extension spring 564 pulls upward on hinged basket 560 such that when there are no books present hinged basket 560 will rise until it is stopped by contact with underside of chute 558. A bound book 554 is shown, in dashed outline, exiting the binder and descending chute 558. The bound book 554 is ballistically launched into hinged basket 560. As books begin to accumulate in basket 560 the increasing load on extension spring 564 allows hinged basket 560 to lower such that the top surface of the last received bound book 554 drops below the exit surface of chute 558

What is claimed is:

1 A binder system for attaching loose document pages into a book form, comprising:
(a) an opening to receive the unbound block of document pages; and
(b) a moveable unheated platen surface for positioning said unbound block; and
(c) a pair of roller jaws for gripping the book and translating said book in two directions; and
(d) a source of adhesive coated flexible binder-tape to affix the spine and the front and rear covers to create a bound book; and
(e) a heated spine platen surface for fusing said binder-tape to said spine; and
(f) a heated side-seal platen pair to fuse said binder-tape to said front and back covers; and
(g) an internal pathway with an associated external opening through which to discharge said bound book from a side substantially different from the insertion side; and
(h) a user interface and controller for sequencing the binding process.

2 The binder of claim 1 further including feed rollers for dispensing said binder-tape from a roll whereby the transverse dimension of said binder-tape is substantially equal to the long dimension of the free edge of said book.

3 The binder of claim 1 further including for an internal storage volume for a roll of transverse binder-tape.

4 The binder of claim 1 further including an opening for the insertion of a flat sheet of said transverse binder-tape.

5 The binder of claim 1 further including both the opening to insert said flat sheet binder-tape in addition to having said feed rollers necessary to utilize said roll of binder-tape.

6 The binder of claim 1 wherein said unheated and heated platens are moveably mounted and synchronized so the active surface of said heated platen can substitute for the positioning surface of said unheated platen.

7 The binder of claim 1 wherein said unheated and heated platens are pivotably mounted and synchronized so that when said platens are rotated sufficiently the positioning surface of said unheated platen is replaced by the working surface of said heated platen.

8 The binder of claim 1 wherein said unheated and heated platens are pivotably mounted and synchronized so that they may be rotated to a position where there will be a gap between said unheated and heated platens of sufficient width for said book to pass through.

9 The binder of claim 1 wherein a strip of said transverse binder-tape is parted from its bulk form by a cutter mechanism.

10 The binder of claim 1 wherein the cut width of said binder-tape is determined automatically by the thickness of said book being bound.

11 The binder of claim 1 wherein the working surfaces of said pair of heated side-seal platens oppose each other and the intervening gap distance is automatically governed relative to the thickness of the current book.

12 The binder of claim 1 wherein said pair of heated side-seal platens has a funnel shaped entry configuration so that when the partially bound book is driven into the heated side-seal platen gap the protruding binder-tape flaps will form up alongside said front and rear covers and be fused to said covers.

13 The binder of claim 1 wherein said binder may be user commanded to cause said bound book to exit from either the unbound book input opening or alternatively from a discharge opening on a substantially different side.

14 The binder of claim 1 wherein the sheet-form binder-tape can be pre-printed with a heat resistant spine image.

15 The binder of claim 1 wherein a detection system is provided to read single or multiple indicia that are a part of said binder-tape.

16 The binder of claim 1 wherein infrared detection devices are provided to read suitable infrared absorbent indicia that are a part of said binder-tape.

17 The binder of claim 1 wherein ultraviolet detection devices are provided to read suitable ultraviolet fluorescent indicia that are a part of said binder-tape.

18 The binder of claim 1 wherein electrical commutators are provided to read suitable electrical conductive indicia that are a part of said binder-tape.

19 The binder of claim 1 further including an optic light pipe that communicates to the exterior of said binder the color of a label attached to said roll of binder-tape.

20 The binder of claim 1 wherein a narrow, unheated area is maintained at both transverse edges of said binder-tape for the prevention of hot adhesive extrusion while attaching said front and rear covers.

21 The binder of claim 1 further including a support structure of fingers designed to lift an extended side flap of said binder-tape away from contact with said heated spine platen.

22 A binder-tape media for use in a binder wherein the transverse dimension of the binder-tape is equal to the long free edge of the book, comprising:
(a) a fabric, paper or other flexible substrate; and
(b) said flexible substrate having a hot melt adhesive coating; and
(c) one or more stripes of ultraviolet fluorescing material coating on the adhesive side of said binder-tape for the purpose of communicating information to said binder.

23 The binder-tape of claim 22 wherein the outermost layer of said hot melt adhesive is selectively coated or patterned providing one extrusion control gap or depression in said adhesive at each longitudinal edge of said binder-tape corresponding to the top and bottom of said book.

24 The binder-tape of claim 22 wherein the outermost layer of said hot melt adhesive is selectively coated or patterned providing two or more extrusion control gaps or depressions in said adhesive at both sides of said binder-tape corresponding to the top and bottom of said book.

25 The binder-tape of claim 22 wherein the outermost layer of said adhesive is selectively coated leaving gaps at one or several fixed positions into which said ultraviolet fluorescing material may be deposited.

26 A binder-tape media for use in a binder wherein the transverse dimension of said binder-tape is equal to the long free edge of the book, comprising:
(d) a fabric, paper or other flexible substrate; and
(e) said flexible substrate having a hot melt adhesive coating; and
(f) one or more stripes of infrared absorbent material coating on the adhesive side of said binder-tape for the purpose of communicating information to said binder.

27 The binder-tape of claim 26 wherein the outermost layer of said hot melt adhesive is selectively coated or patterned providing one extrusion control gap or depression in said adhesive at each longitudinal edge of said binder-tape corresponding to the top and bottom of said book.

28 The binder-tape of claim 26 wherein the outermost layer of said hot melt adhesive is selectively coated or patterned providing two or more extrusion control gaps or depressions in said adhesive at both sides of said binder-tape corresponding to the top and bottom of said book.

29 The binder-tape of claim 26 wherein the outermost layer of said adhesive is selectively coated leaving gaps at one or several fixed positions into which said infrared absorbent material may be deposited.

30 A stacker mechanism for receiving bound books discharged from an opening in the side of a binder, comprising:
(a) an opening into which said bound book makes entry either controllably fed or having been released to fall under the influence of gravity; and
(b) a chute or other guide system to direct and control said book; and
(c) a storage volume to accumulate a quantity of said books.

31 The stacker of claim 30 wherein said bound book drops into a vertically oriented chute that can be controllably sequenced to horizontally reposition said book the spine oriented forward or rearward, and subsequently drop or otherwise lower said bound book onto a storage stack.

32 The stacker of claim 30 wherein said bound book enters a ramp that is curved in a manner that redirects said bound book, under the influence of gravity, in a substantially horizontal orientation followed by nesting onto a storage stack.

33 A binder system for adhesively attaching loose document pages into a book form, comprising:
(a) an opening to receive the unbound block of document pages; and
(b) heated platens to thermally attach any form of binder-tape media to a document bundle so as to create a bound book; and
(c) an emitter/filter/detector device to detect the presence or absence of corresponding ultraviolet fluorescing materials on said binder-tape in order to communicate meaningful data in support of the binding process.

34 A binder system for attaching loose document pages into a book form, comprising:
(d) an opening to receive the unbound block of document pages; and
(e) heated platens to thermally attach any form of binder-tape media to a document bundle so as to create a bound book; and
(f) an emitter/detector device to detect the presence or absence of corresponding infrared absorbent material on said binder-tape in order to communicate meaningful data in support of the binding process.
